(19) United States
(12) Patent Application Publication
(10) Pub. No.: US 2015/0064057 A1
(43) Pub. Date: Mar. 5, 2015

(54) METHODS FOR PRODUCING NIO NANOPARTICLE THIN FILMS AND PATTERNING OF NI CONDUCTORS BY NIO REDUCTIVE SINTERING AND LASER ABLATION

(71) Applicant: The Regents of the University of California, Oakland, CA (US)

(72) Inventors: Costas P. Grigoropoulos, Berkeley, CA (US); Daeho Lee, Albany, CA (US)

(21) Appl. No.: 14/452,291

(22) Filed: Aug. 5, 2014

Related U.S. Application Data
(60) Provisional application No. 61/871,718, filed on Aug. 29, 2013.

(51) Int. Cl. C09D 5/24; H01B 1/02; H01B 13/00

(52) U.S. Cl. CPC C09D 5/24; H01B 13/0036; H01B 13/003; H01B 1/02
USPC 420/441; 427/126.6; 427/554; 427/123; 427/555; 252/519.3

(57) ABSTRACT

A method for producing a nickel-containing surface coating that is metallic and conductive is provided. The method includes contacting a surface of a substrate with a liquid composition that includes nickel oxide nanoparticles, and modifying the nickel oxide nanoparticles to produce a nickel-containing metallic and conductive surface coating on the surface of the substrate. Also provided are nickel-containing (e.g., NiO and Ni containing) surface coatings and methods for making a liquid composition that includes nickel oxide nanoparticles. The methods and compositions find use in a variety of different applications.

### CROSS-REFERENCE TO RELATED APPLICATION

Pursuant to 35 U.S.C. §119(e), this application claims priority to the filing date of U.S. Provisional Application No. 61/871,718, filed on Aug. 29, 2013, the disclosure of which is incorporated herein by reference.

### INTRODUCTION

A thin film is a layer of material ranging from fractions of a nanometer (monolayer) to several micrometers in thickness. Electronic semiconductor devices and optical coatings are applications that use thin-film construction. The act of applying a thin film to a surface is thin-film deposition, which refers to depositing a thin film of a material onto a substrate or onto previously deposited layers. The term “thin” is a relative term, but typically refers to deposition techniques that produce layer thicknesses of 1000 nanometers or less. Deposition techniques can be classified into two broad categories, depending on whether the process is primarily chemical deposition or physical deposition. For example, chemical deposition techniques include plating, chemical solution deposition, spin coating, chemical vapor deposition, and atomic layer deposition. Physical deposition techniques use mechanical, electromechanical or thermodynamic means to produce a thin film of solid, and include sputtering, pulsed laser deposition, cathodic arc deposition and electrospray deposition.

Noble materials have been used to produce thin layers that are resistant to oxidation, even in nanoparticle (NP) configurations. However, the associated material cost may prove prohibitive. Utilizing inexpensive materials may be desirable for thin layer processes to be applied in mainstream manufacturing. Inexpensive metals such as copper (Cu), aluminum (Al) and nickel (Ni) are easily oxidized in air due to their low oxidation potential. Moreover, oxidation is accelerated as the surface area increases, which is more pronounced as particle size becomes smaller. As such, synthesizing NPs of common metals such as Cu, Al and Ni may be difficult and typically requires an inert environment, hence increasing the facility complexity and eventually the material costs. Furthermore, even if their synthesis is successfully implemented, the NPs are easily oxidized during storage and handling and exist as a form of metal oxide during any post processing performed under ambient conditions.

### SUMMARY

A method for producing a nickel-containing surface coating is provided. The method includes contacting a surface of a substrate with a liquid composition that includes nickel oxide nanoparticles, and modifying the nickel oxide nanoparticles to produce a nickel-containing surface coating on the surface of the substrate. Also provided are nickel-containing (e.g., NiO and Ni containing) surface coatings and methods for making a liquid composition that includes nickel oxide nanoparticles. The methods and compositions find use in a variety of different applications.

Aspects of the present disclosure include a method for producing a nickel-containing surface coating, where the method includes contacting a surface of a substrate with a liquid composition that includes nickel oxide nanoparticles, and modifying the nickel oxide nanoparticles coating to produce a nickel-containing surface coating on the surface of the substrate.

In some embodiments, the nickel-containing surface coating includes elemental nickel.

In some embodiments, the modifying includes applying a continuous wave laser to the nickel oxide nanoparticles and applying the laser produces a nickel surface coating. In some embodiments, the modifying includes applying a temporally modulated continuous wave laser to the nickel oxide nanoparticles and applying the laser produces a nickel surface coating.

In some embodiments, the modifying includes applying a pulsed laser to the nickel oxide nanoparticles and applying the laser produces a nickel oxide surface coating. In some embodiments, the modifying includes applying a variable high repetition rate pulsed laser to the nickel oxide nanoparticles and applying the laser produces a nickel surface coating.

In some embodiments, the contacting includes spin coating the liquid composition that includes nickel oxide nanoparticles on the surface of the substrate. In some embodiments, the nickel-containing surface coating is a substantially contiguous surface coating.

In some embodiments, the contacting includes printing the liquid composition that includes nickel oxide nanoparticles on the surface of the substrate.

In some embodiments, the nickel-containing surface coating is a patterned surface coating that includes nickel-containing elements and inter-element areas. In some embodiments, the patterned surface coating has a pitch between the nickel-containing elements ranging from less than 1 μm to 1000 μm.

In some embodiments, the liquid composition that includes the nickel oxide nanoparticles includes an organic liquid. In some embodiments, the organic liquid is toluene or alpha-terpineol.

Aspects of the present disclosure include a nickel-containing surface coating produced by the methods described herein. In some embodiments, the nickel-containing surface coating is a nickel electrode.

Aspects of the present disclosure includes a method for producing a liquid composition that includes nickel oxide nanoparticles, where the method includes treating a liquid composition that includes a nickel coordination complex under reducing conditions to produce a liquid composition that includes nickel oxide nanoparticles.

In some embodiments, the nickel coordination complex includes nickel(II) acetylacetonate.

In some embodiments, the liquid composition that includes the nickel coordination complex further includes a reducing agent. In some embodiments, the reducing agent includes a borane-triethylamine complex.

In some embodiments, the method further includes washing the nickel oxide nanoparticles.

In some embodiments, the method further includes dispersing the nickel oxide nanoparticles in an organic liquid. In some embodiments, the organic liquid is toluene or alpha-terpineol.

In some embodiments, the nickel oxide nanoparticles have an average diameter of 5 nm or less.

In some embodiments, the nickel oxide nanoparticles have an average diameter less than 100 nm.

Aspects of the present disclosure include a liquid composition that includes nickel oxide nanoparticles produced by the methods disclosed herein. In some embodiments, the liquid composition that includes nickel oxide nanoparticles includes an organic liquid and nickel oxide nanoparticles.

Aspects of the present disclosure include a kit that includes a liquid composition that includes nickel oxide nanoparticles as described herein, and an organic liquid.

### BRIEF DESCRIPTION OF THE FIGURES

FIG. 1 (panel a) is an image of a dark-green liquid composition of nickel(II) acetylacetonate dissolved in an oleylamine and oleic acid mixture. FIG. 1 (panel b) is an image taken after injecting borane-triethylamine complex solvated in oleylamine, according to embodiments of the present disclosure. The color changed to dark-brown or black.

FIG. 2 is a high magnification scanning electron microscopy (SEM) image of the synthesized NiO nanoparticles, according to embodiments of the present disclosure. The mean size of the nanoparticles was 2 to 3 nm.

FIG. 3 shows a photoimage (FIG. 3 (panel a)) and SEM image after evaporating solvent (FIG. 3 (panel b)) of a NiO film by NiO nanoparticle spin coating, according to embodiments of the present disclosure. FIG. 3 (panel c) shows an image of an imprinted pattern using a NiO nanoparticle liquid composition according to embodiments of the present disclosure.

FIG. 4 shows a schematic diagram of the laser setup, according to embodiments of the present disclosure.

FIG. 5 (panel a) shows a NiO film on a glass substrate, according to embodiments of the present disclosure. FIG. 5 (panel b) shows Ni patterns produced by laser processing, according to embodiments of the present disclosure. FIG. 5 (panel c) shows Ni patterns after washing away the un-annealed parts, according to embodiments of the present disclosure. The pattern transmittance depended on the pitch of the Ni patterns.

FIG. 6 (panel a) to FIG. 6 (panel d) show SEM images of Ni patterns on a glass substrate, according to embodiments of the present disclosure.

FIG. 7A shows a voltage vs. current (V-I) plot for the Ni electrode, and FIG. 7B shows an optical image of the Ni pattern generated with a focused laser beam, according to embodiments of the present disclosure.

FIG. 8 (panel a) shows a photoimage of Ni patterns on a polyimide substrate with 20 μm (FIG. 8 (panel b)) and 80 μm (FIG. 8 (panel c)) pattern pitches, according to embodiments of the present disclosure.

FIG. 9 (panel a) and FIG. 9 (panel b) show optical images of the ablated NiO patterns on a glass substrate by a nanosecond laser with a large pitch (FIG. 9 (panel a)) and a small pitch (FIG. 9 (panel b)), according to embodiments of the present disclosure.

FIG. 10 shows optical images of the ablated NiO patterns on a glass substrate by a femtosecond laser, according to embodiments of the present disclosure.

FIG. 11 shows SEM images of imprinted NiO line (FIG. 11 (panel a)) and mesh (FIG. 11 (panel b)) patterns, according to embodiments of the present disclosure. FIG. 11 (panel c) shows optical images of a combination of NiO line and mesh patterns. FIG. 11 (panel d) shows Ni patterns produced after reduction annealing of NiO patterns by laser annealing processing, according to embodiments of the present disclosure.

FIG. 12 shows an image of NiO pattern by a soft imprinting method. FIG. 12 (right), upper inset, shows a cross section measured by laser scanning confocal microscope. FIG. 12 (right), lower left inset, shows a Ni pattern defined after laser reduction annealing process, according to embodiments of the present disclosure.

FIG. 13 (panel a) shows a transmission electron microscopy (TEM) image of NiO nanoparticles synthesized according to embodiments of the present disclosure. FIG. 13 (panel b) shows a spin-coated NiO thin film on a glass substrate. FIG. 13 (panel c) shows a SEM image of the surface of the NiO film shown in FIG. 13 (panel b). FIG. 13 (panel d) shows a schematic illustration of a laser direct writing system according to embodiments of the present disclosure. FIG. 13 (panel e) shows mesh-type Ni electrodes produced by laser reduction sintering of an NiO thin film. Each square area was produced using mesh patterns of different pitches. The inset is a photograph of glossy surfaces of plane-type Ni electrodes under natural illumination. FIG. 13 (panel f) shows an image of arbitrary patterns (letters) on a glass substrate produced by a laser direct writing process linked with a CAD system, according to embodiments of the present disclosure.

FIG. 14 (panel a) shows a top view SEM image of a single Ni electrode, according to embodiments of the present disclosure. The line width was about 6.5 μm. FIG. 14 (panel b) and FIG. 14 (panel c) show top view SEM images of mesh-type electrodes with different magnifications. The mesh-type Ni grids were produced by two-time laser scanning—one time per each direction. FIG. 14 (pane d) and FIG. 14 (panel e) shows tilted view images of the intersection area of the mesh patterns at different magnifications. FIG. 14 (panel f) shows an atomic force microscopy (AFM) image of a single electrode. The cross-sectional shape is shown in the graph and was plotted with different axis scales on the x-axis (μm) vs. y-axis (nm).

FIG. 15 (panel a) shows a graph of substrate-based transmittance data of the mesh-type electrodes on a glass substrate with different pitches, according to embodiments of the present disclosure. FIG. 15 (panel b) shows a photoimage of several 1 cm×1 cm mesh patterns. The number above each mesh pattern indicates the corresponding pitch of the mesh patterns. FIG. 15 (panel c) shows a graph of the sheet resistance and the corresponding transmittance at 550 nm wavelength of each area shown in FIG. 15 (panel b). FIG. 15 (panel d) shows a plot of the resistivity data of the Ni electrodes (average thickness: 38 nm) as a function of laser power at a fixed 10 mm/s scanning speed. The resistivity of the bulk Ni was 69.3 nΩ·m.

FIG. 16 (panel a) shows a SEM image of a mesh-type electrode according to embodiments of the present disclosure after performing a tape-pull test several times with a highly adhesive tape. FIG. 16 (panel b) shows images of mesh-type Ni electrodes with different pitches on a polyimide substrate, according to embodiments of the present disclosure. The upper and lower insets show bright-field microscopic images of the mesh patterns of 20 μm and 80 μm pitches, respectively. FIG. 16 (panel c) shows a graph of measured resistance variation (R/R₀) after a cyclic bending test with electrodes on a 3.8 cm×4.8 cm polyimide substrate.

FIG. 17 (panel a) shows a schematic diagram of a touchscreen panel, according to embodiments of the present disclosure. FIG. 17 (panel b) shows a photoimage of a 4-wire resistive touchscreen panel, according to embodiments of the present disclosure. FIG. 17 (panel c) shows images of a demonstration of the operation of a Ni touchscreen panel (active area: 3 cm×3.7 cm) by writing “UCB LTL” with a stylus pen on the touchscreen panel, according to embodiments of the present disclosure.

### DETAILED DESCRIPTION

A method for producing a nickel-containing surface coating is provided. The method includes contacting a surface of a substrate with a liquid composition that includes nickel oxide nanoparticles, and modifying the nickel oxide nanoparticles to produce a conductive nickel surface coating on the surface of the substrate. Also provided are nickel-containing (e.g., NiO and Ni containing) surface coatings and methods for making a liquid composition that includes nickel oxide nanoparticles. The methods and compositions find use in a variety of different applications.

### Methods for Producing a Nickel-Containing Surface Coating

In certain embodiments, a liquid composition that includes nickel oxide nanoparticles may be used to produce a nickel-containing surface coating on the surface of a substrate. For example, aspects of the present disclosure include a method for producing a nickel-containing surface coating. By “nickel-containing” is meant that the surface coating includes elemental nickel (Ni), a nickel compound, such as nickel oxide (NiO), or a combination of elemental nickel and a nickel compound.

In certain embodiments, the method for producing a nickel-containing surface coating includes contacting a surface of a substrate with a liquid composition that includes nickel oxide nanoparticles. In some instances, contacting the surface of the substrate with the liquid composition that includes nickel oxide nanoparticles is sufficient to produce a thin layer of the liquid composition that includes nickel oxide nanoparticles on the surface of the substrate. For example, a thin layer of nickel oxide nanoparticles may be formed on the surface of the substrate. By “thin layer” is meant a layer of the liquid composition and/or nickel oxide nanoparticles that has a thickness in the micron range, such as 100 μm or less, or 75 μm or less, or 50 μm or less, or 25 μm or less, or 20 μm or less, or 15 μm or less, or 10 μm or less, or 7 μm or less, or 5 μm or less, or 3 μm or less, or 2 μm or less, or 1 μm or less. “Thin layers” of the liquid composition and/or nickel oxide nanoparticles also include layers that have a thickness in the nanoscale range, such as 750 nm or less, 500 nm or less, 400 nm or less, 300 nm or less, 200 nm or less, 100 nm or less, 90 nm or less, 80 nm or less, 70 nm or less, 60 nm or less, 50 nm or less, 40 nm or less, 30 nm or less, 20 nm or less, or 10 nm or less. For instance, contacting the surface of the substrate with the liquid composition that includes nickel oxide nanoparticles may produce a layer of the liquid composition that includes nickel oxide nanoparticles and/or a layer of the nickel oxide nanoparticles that has a thickness ranging from 1 nm to 100 nm, such as from 5 nm to 90 nm, or 5 nm to 80 nm, or 5 nm to 70 nm, or 5 nm to 60 nm, or 5 nm to 50 nm, or 10 nm to 50 nm, or 20 nm to 50 nm, or 20 nm to 40 nm, or 30 nm to 40 nm. In some embodiments, contacting the surface of the substrate with the liquid composition that includes nickel oxide nanoparticles may produce a layer of the liquid composition that includes nickel oxide nanoparticles and/or a layer of the nickel oxide nanoparticles that has a thickness ranging from 1 μm to 100 μm, such as from 1 μm to 90 μm, or 1 μm to 80 μm, or 1 μm to 70 μm, or 1 μm to 60 μm, or 1 μm to 50 μm, or 1 μm to 50 μm, or 1 μm to 40 μm, or 1 μm to 30 μm, or 1 μm to 20 μm, or 1 μm to 10 μm, or 1 μm to 5 μm. In certain instances, the thickness of the liquid composition that includes nickel oxide nanoparticles and/or the layer of the nickel oxide nanoparticles ranges from 10 nm to 500 nm. In certain instances, the thickness of the liquid composition that includes nickel oxide nanoparticles and/or the layer of the nickel oxide nanoparticles ranges from 1 μm to 5 μm, such as about 1 μm.

In certain embodiments, the layer of the liquid composition that includes nickel oxide nanoparticles on the surface of the substrate is substantially contiguous. By contiguous is meant that the layer of the liquid composition that includes nickel oxide nanoparticles covers a portion of the surface of the substrate, such as substantially the entire area of a portion of the surface of the substrate. A contiguous layer of the liquid composition that includes nickel oxide nanoparticles may cover substantially the entire area of a portion of the surface of the substrate such that the underlying surface in that portion of the substrate is not significantly exposed to the surrounding environment.

In certain instances, contacting a surface of a substrate with a liquid composition that includes nickel oxide nanoparticles is performed using a liquid deposition technique for depositing a liquid on a surface of a substrate. In some instances, the liquid deposition technique includes, but not limited to, spin-coating, dip coating, printing, imprinting, combinations thereof, and the like. In some instances, the liquid deposition technique is printing, such as, but not limited to, inkjet printing, screen printing, gravure printing, flexo printing, offset printing, combinations thereof, and the like. In some instances, the liquid deposition technique is imprinting, such as, but not limited to, micro-imprinting and nano-imprinting, combinations thereof, and the like. For example, the surface of the substrate may be coated with a layer of the liquid composition that includes nickel oxide nanoparticles by spin-coating the liquid composition that includes nickel oxide nanoparticles on the surface of the substrate. In some cases, spin-coating the liquid composition that includes nickel oxide nanoparticles on the surface of the substrate produces a substantially contiguous layer of the liquid composition that includes nickel oxide nanoparticles on the surface of the substrate. In some instances, the surface of the substrate may be coated with a layer of the liquid composition that includes nickel oxide nanoparticles by dip coating the substrate in the liquid composition that includes nickel oxide nanoparticles. For example, the substrate may be dipped into a liquid composition that includes nickel oxide nanoparticles. In some cases, dip coating the substrate in the liquid composition that includes nickel oxide nanoparticles produces a substantially contiguous layer of the liquid composition that includes nickel oxide nanoparticles on the surface of the substrate. In some instances, the substantially contiguous layer of the liquid composition that includes nickel oxide nanoparticles covers substantially the entire surface of the substrate.

In certain embodiments, contacting a surface of a substrate with a liquid composition that includes nickel oxide nanoparticles includes printing the liquid composition that includes nickel oxide nanoparticles onto the surface of the substrate. In these embodiments, the liquid composition that includes nickel oxide nanoparticles (as described herein) may be printed on the surface of the substrate using a printer. For example, an inkjet printer may be used to print the liquid composition that includes nickel oxide nanoparticles (e.g., the NiO ink) onto the surface of the substrate. In some instances, printing the liquid composition that includes nickel oxide nanoparticles onto the surface of the substrate may produce a substantially contiguous layer of the liquid composition that includes nickel oxide nanoparticles on the surface of the substrate. In other embodiments, printing the liquid composition that includes nickel oxide nanoparticles onto the surface of the substrate is performed to produce substantially discontinuous areas of nickel oxide nanoparticles on the surface of the substrate. In some cases, the substantially discontinuous areas of nickel oxide nanoparticles may be substantially surrounded by areas of the surface of the substrate that do not include significant amounts of nickel oxide nanoparticles. For example, a single discontinuous area of nickel oxide nanoparticles may cover an area of the surface of the substrate of 0.25 μm² or more, such as 0.5 μm² or more, or 0.75 μm² or more, or 1 μm² or more, or 1.5 μm² or more, or 2 μm² or more, or 3 μm² or more, or 4 μm² or more, or 5 μm² or more, or 6 μm² or more, or 7 μm² or more, or 8 μm² or more, or 9 μm² or more, or 10 μm² or more, or 15 μm² or more, or 20 μm² or more, or 25 μm² or more, or 30 μm² or more, or 40 μm² or more, or 50 μm² or more, or 75 μm² or more, or 100 μm² or more, or 150 μm² or more, or 200 μm² or more, or 250 μm² or more, or 300 μm² or more, or 400 μm² or more, or 500 μm² or more, or 600 μm² or more, or 700 μm² or more, or 800 μm² or more, or 900 μm² or more, or 1000 μm² or more.

In certain embodiments, contacting a surface of a substrate with a liquid composition that includes nickel oxide nanoparticles includes imprinting the liquid composition that includes nickel oxide nanoparticles onto the surface of the substrate. Imprinting may include pressing or stamping the liquid composition that includes nickel oxide nanoparticles onto the surface of the substrate. In some instances, imprinting the liquid composition that includes nickel oxide nanoparticles onto the surface of the substrate may produce a substantially contiguous layer of the liquid composition that includes nickel oxide nanoparticles on the surface of the substrate. In other embodiments, imprinting the liquid composition that includes nickel oxide nanoparticles onto the surface of the substrate is performed to produce substantially discontinuous areas of nickel oxide nanoparticles on the surface of the substrate, as described above.

In certain embodiments, contacting the surface of the substrate with the liquid composition that includes nickel oxide nanoparticles may produce a patterned surface coating. For example, printing or imprinting methods described herein may be used to produce a patterned surface coating of the liquid composition that includes nickel oxide nanoparticles on the surface of the substrate. In some cases, the patterned surface coating includes nickel-containing elements and inter-element areas. The nickel-containing elements may include nickel and/or a nickel compound, such as nickel oxide. For example, the nickel-containing elements may include nickel oxide nanoparticles as described herein. In certain cases, the nickel-containing elements are adjacent to one or more inter-element areas. The inter-element areas may be areas that do not include significant amounts of nickel or a nickel compound, such as nickel oxide nanoparticles. In some instances, the patterned surface coating is an arbitrary pattern (e.g., the patterned surface coating may be in any desired shape or pattern that can be printed and/or imprinted on the surface of the substrate). In some embodiments, the patterned surface coating has a grid pattern. By “grid” is meant that the pattern includes a first series of elongated elements that are substantially parallel to each other, and a second series of elongated elements that are substantially parallel to each other, where the second series of parallel elongated elements intersects the first series of parallel elongated elements. In some instances, the first series of parallel elongated elements is substantially perpendicular to the second series of parallel elongated elements. In some instances, the inter-element areas of a grid form a series of squares or rectangles between the intersecting elements of the first and second series of elongated elements. A grid may be characterized by its pitch, which is the distance between parallel elongated elements in the grid. In certain embodiments, the grid has a pitch ranging from 1 μm to 1000 μm, such as from 1 μm to 900 μm, or 1 μm to 800 μm, or 1 μm to 700 μm, or 1 μm to 600 μm, or 1 μm to 500 μm, or 1 μm to 450 μm, or 1 μm to 400 μm, or 1 μm to 350 μm, or 1 μm to 300 μm, or 1 μm to 250 μm, or 1 μm to 200 μm, or 1 μm to 150 μm, or 1 μm to 100 μm, or 5 μm to 100 μm, or 10 μm to 100 μm, or 10 μm to 90 μm, or 10 μm to 80 μm, or 10 μm to 70 μm, or 10 μm to 60 μm, or 10 μm to 50 μm, or 10 μm to 40 μm, or 10 μm to 30 μm. In some cases, the grid has a pitch of 10 μm. In some cases, the grid has a pitch of 20 μm. In some cases, the grid has a pitch of 40 μm. In some cases, the grid has a pitch of 60 μm. In some cases, the grid has a pitch of 80 μm. In some cases, the grid has a pitch of 100 μm. In some cases, the grid has a pitch of 120 μm. In some cases, the grid has a pitch of 140 μm. In some cases, the grid has a pitch of 160 μm. In some cases, the grid has a pitch of 180 μm. In some cases, the grid has a pitch of 200 μm. In some cases, the grid has a pitch of 500 μm.

In certain embodiment, the elongated elements have a length greater than their width. For example, the elongated elements may have a length that is two or more times greater than the width, such as a length that is 5 times or more, or 10 times or more, including 20 times or more, or 50 times or more, such as 100 times or more, or 250 times or more, or 500 times or more, or 1000 times or more greater than the width. In certain embodiments, the elongated elements are substantially linear. In other embodiments, the elongated elements may be non-linear (e.g., curved). In certain embodiments, the elongated elements have microscale dimensions. For example, the elongated elements may have a width ranging from 1 μm to 100 μm, such as from 1 μm to 75 μm, including from 1 μm to 50 μm, or from 1 μm to 25 nm, or from 1 μm to 10 μm. In some instances, the elongated elements have a width of 5 μm. In certain cases, the elongated elements have a length ranging from 10 μm to 100 cm, such as from 10 μm to 75 cm, including from 50 μm to 50 cm, or from 100 μm to 25 cm, or from 100 μm to 10 cm, or from 100 μm to 5 cm, or from 100 μm to 4 cm, or from 100 μm to 3 cm, or from 100 μm to 2 cm, or from 100 μm to 1 cm, or from 100 μm to 0.5 cm, or from 100 μm to 1000 μm. In some cases, the elongated elements have a thickness ranging from 1 nm to 100 nm, such as from 5 nm to 90 nm, or 5 nm to 80 nm, or 5 nm to 70 nm, or 5 nm to 60 nm, or 5 nm to 50 nm, or 10 nm to 50 nm, or 20 nm to 50 nm, or 20 nm to 40 nm, or 30 nm to 40 nm. In certain instances, the elongated elements have a thickness ranging from 20 nm to 50 nm, such as 40 nm or 30 nm.

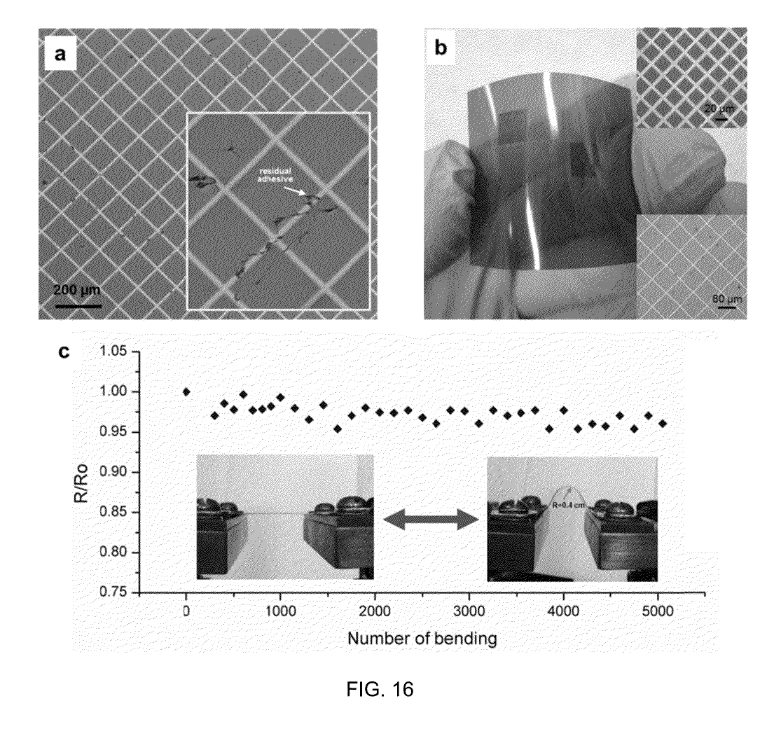

In certain embodiments, the substrate onto which the liquid composition that includes nickel oxide nanoparticles is deposited is a substantially rigid substrate. In these embodiments, the substrate may not significantly bend when a pressure is applied to the substrate. For example, the substrate may be composed of glass, such as soda lime glass. In certain embodiments, the substrate onto which the liquid composition that includes nickel oxide nanoparticles is deposited is a flexible substrate. In these embodiments, the substrate may bend (e.g., bend without breaking) when a pressure is applied to the substrate (see FIG. 16 (panel b) and FIG. 16 (panel c)). For instance, the substrate may be composed of a flexible material, such as, but not limited, to a plastic (e.g., polyimide, polyethylene terephthalate (PET), etc.), and the like.

The liquid composition used for the production of nickel-containing surface coatings as discussed above may be produced according to any convenient nickel oxide nanoparticle production method. In certain embodiments, a liquid composition of nickel oxide nanoparticles is produced according to the methods discussed in more detail below. Accordingly, aspects of the present disclosure include a method for producing a liquid composition that includes nickel oxide nanoparticles.

In the method for producing a liquid composition that includes nickel oxide nanoparticles, the method includes treating a liquid composition that includes a nickel coordination complex to produce the liquid composition that includes the nickel oxide nanoparticles (NiO nanoparticles). A coordination complex is a compound that includes a central atom or ion (e.g., Ni) that is bound to ligands (complexing agents) through dipolar bonds. In certain embodiments, the nickel coordination complex is nickel(II) acetylacetonate (Ni(acac)₂), where “acac” is the anion C₅H₇O₂⁻ derived from acetylacetone. The fluid or liquid used to make the liquid composition that includes the nickel coordination complex can be any liquid compatible with the reagents, products and reaction conditions. For instance, the liquid used in the production of the nickel oxide nanoparticles can be a liquid compatible with nickel coordination complex and/or the produced nickel oxide nanoparticles. In some instances, the reaction liquid includes oleylamine.

In certain embodiments, the method of producing a liquid composition that includes nickel oxide nanoparticles includes heating a liquid composition that includes the nickel coordination complex. In some cases, the liquid composition is heated to a temperature sufficient to degas dissolved oxygen and/or evaporate moisture from the liquid composition. For example, the liquid composition may be heated to a temperature of greater than 100° C., such as 110° C. In some embodiments, the liquid composition is heated for a period of time sufficient to degas dissolved oxygen and/or evaporate moisture from the liquid composition. In certain cases, the period of time for heating the liquid composition is 30 minutes or more, such as 45 minutes or more, or 1 hour or more, or 1.5 hours or more, or 2 hours or more. In some instances, the period of time for heating the liquid composition is 1 hour or more. After heating the liquid composition of the nickel coordination complex, the method may include reducing the temperature (e.g., cooling) of the liquid composition. For instance, the method may include reducing the temperature of the liquid composition to below 100° C., such as cooling the liquid composition to 90° C.

In certain embodiments, treating the liquid composition of the nickel coordination complex to produce the liquid composition of nickel oxide nanoparticles includes treating the liquid composition of the nickel coordination complex under reducing conditions to produce the nickel oxide nanoparticles. For instance, treating the liquid composition of the nickel coordination complex under reducing conditions may include adding a reducing agent to the liquid composition of the nickel coordination complex. The reducing agent may be any suitable reducing agent capable of forming the nickel oxide nanoparticles from the nickel coordination complex. In some instances, the reducing agent is a borane-triethylamine complex. In some cases, the reducing agent does not include a borane-tributylamine complex.

In some cases, adding the reducing agent to the liquid composition of the nickel coordination complex produces a reaction mixture. In certain instances, the reaction mixture is heated. For example, the reaction mixture may be heated to a temperature ranging from 75° C. to 100° C., such as 90° C. In some embodiments, the reaction mixture is heated for a period of time sufficient to form nickel oxide nanoparticles from the nickel coordination complex. In certain cases, the period of time for heating the reaction mixture is 30 minutes or more, such as 45 minutes or more, or 1 hour or more, or 1.5 hours or more, or 2 hours or more. In some embodiments, the period of time for heating the reaction mixture is 1 hour. In certain embodiments, the reaction mixture is stirred while the reaction mixture is heated as described above.

In certain embodiments, the reaction for producing the nickel oxide nanoparticles is performed under standard ambient conditions. For example, the reaction may be performed at standard ambient pressure (e.g., 1 atm). In these embodiments, the method for producing a liquid composition that includes nickel oxide nanoparticles may be performed without applying a vacuum to the reaction mixture. Stated another way, the method for producing a liquid composition that includes nickel oxide nanoparticles does not require a reduction in ambient pressure significantly below standard ambient pressure (e.g., 1 atm).

In certain embodiments, the reaction for producing the nickel oxide nanoparticles is performed in a standard atmospheric environment. For example, the reaction may be performed while the reaction mixture is exposed to the standard atmospheric environment. In these embodiments, the method for producing a liquid composition that includes nickel oxide nanoparticles may be performed without providing an inert gas environment (e.g., Ar, N₂, and the like) around the reaction mixture.

In certain embodiments, after the nickel oxide nanoparticles have been formed, the reaction mixture is cooled, such as cooled to about room temperature. For example, after the nickel oxide nanoparticles have been formed, the reaction mixture may be cooled to about 25° C., such as within a range of temperature of 15° C. to 30° C., including a range of 20° C. to 30° C. In certain cases, the reaction mixture is cooled passively, for example, by stirring the reaction mixture at ambient temperature in the absence of a heat source. In some cases, the reaction mixture is cooled by applying a cooling source to the reaction mixture or the vessel that contains the reaction mixture. For instance, the cooling source may include a fluid having a temperature less than the temperature of the reaction mixture that is circulated around an external surface of the vessel that contains the reaction mixture.

In some instances, the method includes isolating the nickel oxide nanoparticles from the reaction mixture. For example, the method may include washing the nickel oxide nanoparticles in the reaction mixture with a wash liquid, such as ethanol. In certain instances, several washing steps are performed, such as 2 or more washing steps, or 3 or more, or 4 or more, or 5 or more, or 6 or more, or 7 or more, or 8 or more, or 9 or more, or 10 or more washing steps. In certain embodiments, washing the nickel oxide nanoparticles includes contacting the liquid composition of nickel oxide nanoparticles with a wash liquid. The wash liquid may be mixed (e.g., by stirring, shaking, or other forms of agitation) with the nickel oxide nanoparticles. Subsequently, the washed nickel oxide nanoparticles may be isolated from the wash liquid. Isolating the nickel oxide nanoparticles from the wash liquid may include any convenient isolation technique, such as, but not limited to, centrifugation, filtering, magnetic separation techniques, and the like. In certain embodiments, In some instances, isolating the nickel oxide nanoparticles includes centrifuging the nickel oxide nanoparticles. One or more centrifugation steps may be performed during the isolating and/or washing steps of the method.

The resulting nickel oxide nanoparticles are, in some embodiments, nano-sized. By “nanoparticles”, “nanoscale” or “nano-sized” is meant that the nickel oxide particles have an average diameter in the nanometer range, such as 1000 nm or less, or 900 nm or less, or 800 nm or less, or 700 nm or less, or 600 nm or less, or 500 nm or less, or 400 nm or less, or 300 nm or less, or 200 nm or less, or 100 nm or less. For instance, the nickel oxide nanoparticles may have an average diameter of 100 nm or less, such as 90 nm or less, or 80 nm or less, or 70 nm or less, or 60 nm or less, or 50 nm or less, or 40 nm or less, or 30 nm or less, or 25 nm or less, or 20 nm or less, or 15 nm or less, or 10 nm or less, or 9 nm or less, or 8 nm or less, or 7 nm or less, or 6 nm or less, or 5 nm or less, or 4 nm or less, or 3 nm or less, or 2 nm or less, or 1 nm or less. In some cases, the nickel oxide nanoparticles have an average diameter ranging from 1 nm to 10 nm, such as 2 nm to 9 nm, or 3 nm to 8 nm, or 3 nm to 7 nm. In certain embodiments, the nickel oxide nanoparticles have an average diameter of 5 nm or less, such as 4 nm or 3 nm. By “average” is meant the arithmetic mean.

In certain embodiments, the nickel oxide nanoparticles are approximately spherical in shape. In certain embodiments, the nickel oxide nanoparticles are crystalline. The nickel oxide nanoparticles may have other shapes, such as, but not limited to, rod, ellipsoid, cone, star, amorphous, and the like.

In certain embodiments, the isolated and/or washed nickel oxide nanoparticles are dispersed in a liquid to produce a liquid composition that includes nickel oxide nanoparticles. In certain instances, the liquid is a liquid that is compatible with the nickel oxide nanoparticles and is also compatible with subsequent reactions and/or processing that use the nickel oxide nanoparticles. For example, the liquid may be a liquid that is compatible with subsequent uses of the nickel oxide nanoparticles (as described in more detail herein), such as, but not limited to, spin-coating, printing (e.g., inkjet printing), imprinting (e.g., soft imprinting), and the like. In some embodiments, the liquid is an organic liquid. In certain embodiments, the liquid is a non-polar organic liquid, such as toluene. In some instances, the non-polar organic liquid does not include hexane. In certain embodiments, the liquid is a polar organic liquid, such as a-terpineol (i.e., alpha-terpineol). In some embodiments, the liquid is an organic liquid, such as pentanol or ethylene glycol. Combinations of the above organic liquids may also be used. In some instances, the liquid composition includes one or more additives, such as, but not limited to, polyvinylpyrrolidone (PVP). In some instances, the liquid composition that includes nickel oxide nanoparticles may be referred to as an “ink”, a “nickel oxide ink” or a “NiO ink”.

In certain embodiments, the nickel oxide nanoparticles do not substantially agglomerate in solution. By “agglomerate” is meant the association of a plurality of nanoparticles into a mass or group. In some instances, a liquid composition that includes nickel oxide nanoparticles that does not contain significant agglomerations of nickel oxide nanoparticles may facilitate subsequent uses of the nickel oxide nanoparticles, such as, but not limited to, spin-coating, printing (e.g., inkjet printing), imprinting (e.g., soft imprinting), and the like. In certain embodiments, the liquid composition that includes nickel oxide nanoparticles is a colloidal suspension. By “colloid” or “colloidal suspension” is meant a substance in which dispersed insoluble particles are suspended throughout a liquid. A colloid has a dispersed phase (the suspended particles) and a continuous phase (the liquid of suspension). In certain instances, the dispersed phase of the colloidal suspension does not significantly settle out of solution. For example, in some instances, the nickel oxide nanoparticles do not significantly settle out of solution during storage.

Following the application of the liquid composition that includes nickel oxide nanoparticles onto the surface of a substrate as described above, the thin layer of nickel oxide nanoparticles may be modified. As such, embodiments of the method further include modifying the nickel oxide nanoparticles on the surface of the substrate. In certain embodiments, modifying the nickel oxide nanoparticles on the surface of the substrate causes a change in the physical or chemical properties of the nickel oxide nanoparticles. In some cases, modifying the nickel oxide nanoparticles on the surface of the substrate causes both a physical change and a chemical change in the nickel oxide nanoparticles. For example, modifying the nickel oxide nanoparticles on the surface of the substrate may cause reductive sintering and/or ablation of the nickel oxide nanoparticles, as discussed in more detail below. In some instances, the reductive sintering produces a conductive nickel layer, e.g., a conductive nickel film.

In certain embodiments, modifying the nickel oxide nanoparticles on the surface of the substrate includes applying a laser to the nickel oxide nanoparticles to produce a conductive nickel surface coating on the surface of the substrate. In certain embodiments, modifying the nickel oxide nanoparticles on the surface of the substrate includes applying a laser to the nickel oxide nanoparticles to produce a conductive nickel-rich surface coating on the surface of the substrate. By “nickel-rich” is meant that the surface coating includes elemental nickel at a greater proportion as compared to other nickel compounds, such as nickel oxide. For instance, the laser may be applied to the layer of the liquid composition that includes nickel oxide nanoparticles on the surface of the substrate. The laser may be applied to substantially the entire surface of the substrate. For example, the laser may be applied to substantially the entire layer of nickel oxide nanoparticles on the surface of the substrate, such as substantially the entire contiguous layer of nickel oxide nanoparticles as described above, or substantially the entire pattern (e.g., grid pattern) of nickel oxide nanoparticles as described above. As such, in some embodiments, the method of producing a nickel-containing surface coating includes forming a pattern (e.g., grid pattern) of nickel oxide nanoparticles on a surface of a substrate and contacting substantially the entire surface of the substrate (including the pattern of nickel oxide nanoparticles formed on the surface of the substrate) with a laser.

In other embodiments, the laser is applied to a portion of the surface of the substrate (e.g., a portion of the layer of nickel oxide nanoparticles on the surface of the substrate). For example, the laser may be applied to the surface of the substrate in a pattern. Embodiments of the pattern are described above and include an arbitrary pattern (e.g., any desired pattern), such as a grid pattern as described above. As such, in some embodiments, the method of producing a nickel-containing surface coating includes contacting substantially the entire surface of the substrate with a liquid composition that includes nickel oxide nanoparticles and applying a laser in a pre-determined pattern to a portion of surface of the substrate.

In certain embodiments, applying the laser to the liquid composition that includes nickel oxide nanoparticles on the surface of the substrate causes a change in the physical and/or chemical properties of the nickel oxide nanoparticles. In some cases, applying the laser to the liquid composition that includes nickel oxide nanoparticles on the surface of the substrate causes a physical change and a chemical change in the nickel oxide nanoparticles. For example, applying the laser to the liquid composition that includes nickel oxide nanoparticles on the surface of the substrate may cause reductive sintering of the nickel oxide nanoparticles. In some instances, reductive sintering of the nickel oxide nanoparticles produces a conductive nickel-rich film, e.g., a conductive elemental nickel film. In some cases, the conductive nickel-rich film has minimal or no significantly detectable presence of trace oxygen. The term “reductive sintering” refers to a process where a chemical reduction occurs just before an ensuing sintering process, such as immediately prior to a sintering process. In some cases, the nickel oxide is reduced to elemental nickel (also referred to herein as “nickel” or “Ni”) upon application of the laser to the nickel oxide nanoparticles. In some cases, the reduced nickel nanoparticles are sintered upon application of a laser. In some instances, sintering the reduced nickel nanoparticles produces conductive nickel patterns on the surface of the substrate. In some cases, both reduction of nickel oxide to elemental nickel and sintering occur substantially simultaneously upon application of the laser to the nickel oxide nanoparticles. In some embodiments, reduction annealing of the nickel oxide nanoparticles produces a nickel surface coating as the nickel oxide is reduced to elemental nickel.

In certain embodiments, applying the laser to the nickel oxide nanoparticles may be performed according to a predetermined pattern, as described herein. In these embodiments, reduction annealing of the layer of nickel oxide nanoparticles produces a pattern of nickel on the surface of the substrate where the nickel oxide is reduced to elemental nickel during the reduction annealing process. For example, the laser may be applied to the surface of the substrate (e.g., a substantially contiguous layer of nickel oxide nanoparticles on the surface of the substrate) in a predetermined pattern, such as a grid pattern as described herein, to produce a grid pattern composed of elemental nickel on the surface of the substrate. The areas of the pattern not exposed to the reduction annealing process (e.g., not contacted with the laser) may be washed off the surface of the substrate, leaving the reduced and annealed elemental nickel on the surface of the substrate.

In some embodiments, the method of producing a nickel-containing surface coating includes forming a pattern (e.g., grid pattern) of nickel oxide nanoparticles on a surface of a substrate, such as for example by printing or imprinting a pattern of nickel oxide nanoparticles on the surface of the substrate as described herein. Subsequently, the laser (e.g., a continuous wave laser) may be applied to the surface of the substrate (e.g., the pattern of nickel oxide nanoparticles on the surface of the substrate) to perform a reductive sintering process on the pattern of nickel oxide nanoparticles on the surface of the substrate. As such, in these embodiments, the reductive sintering process produces a conductive pattern (e.g., a grid pattern as described herein) of elemental nickel on the surface of the substrate.

In certain instances, reductive sintering of the nickel oxide nanoparticles is produced by applying a laser, such as a continuous waver (CW) laser, to the nickel oxide nanoparticles. In certain embodiments, the CW laser has a wavelength of 514.5 nm. In other embodiments, an ultraviolet (UV) laser or near infrared laser is used. In certain embodiments, the CW laser has a power ranging from 1 mW to 50 mW, such as 5 mW to 50 mW, or 10 mW to 50 mW, or 10 mW to 40 mW, or 10 mW to 30 mW, or 10 mW to 25 mW. In some cases, the CW laser has a power ranging from 10 mW to 30 mW. In some cases, the CW laser has a power ranging from 15 mW to 40 mW. In some cases, where the sample translation or the laser beam scanning speed is high, the CW laser power is in the range of several hundreds of mW, such as ranging from 100 mW to 1000 mW, or 200 mW to 1000 mW, or 300 mW to 1000 mW, or 400 mW to 1000 mW, or 500 mW to 1000 mW.

In some cases, the sample may be translated (e.g., linearly translated in an x- and/or y-direction) at a speed ranging from 1 m/s to 50 m/s, such as from 1 m/s to 40 m/s, or 1 m/s to 30 m/s, or 1 m/s to 20 m/s, or 1 m/s to 10 m/s. In some cases, the laser beam is scanned (e.g., in an x- and/or y-direction relative to the surface of the substrate) at a speed ranging from 1 m/s to 50 m/s, such as from 1 m/s to 40 m/s, or 1 m/s to 30 m/s, or 1 m/s to 20 m/s, or 1 m/s to 10 m/s. In some cases, the amplitude power of the laser beam is temporally modulated. In some cases, the modulation is done using an acousto-optic modulator (AOM).

In some cases, reductive sintering of the nickel oxide nanoparticles is produced by applying a pulsed laser to the nickel oxide nanoparticles. For example, in embodiments where the substrate is a heat-sensitive polymer of low glass transition temperature, a short pulsed laser (e.g., nanosecond pulses and shorter) can be used. The laser irradiation repetition rate can vary from 1 Hz to 100 MHz, depending on the processing protocol. In certain embodiments, the pulsed laser has a wavelength of 514.5 nm. In other embodiments, an ultraviolet (UV) laser or near infrared laser is used. The average power of the pulsed laser can vary from 1 mW to 100 W, such as ranging from 1 mW to 75 W, or 5 mW to 50 W, or 5 mW to 25 W, or 5 mW to 10 W.

In some cases, applying the laser to the liquid composition that includes nickel oxide nanoparticles on the surface of the substrate causes ablation of the nickel oxide nanoparticles. By “ablated” or “ablation” is meant that material from a surface of a substrate is removed by irradiating the substrate with an irradiation source (e.g., a laser). In certain embodiments, ablation of the nickel oxide nanoparticles causes removal of the nickel oxide nanoparticles from the surface of the substrate in the areas contacted by the laser. Ablation of portions of the layer of nickel oxide nanoparticles may form void areas on the surface of the substrate in the areas contacted by the laser. In some instances, the void areas are areas where there is no significant nickel or nickel oxide, such as the inter-element areas of a grid pattern, as described above. In certain embodiments, ablation of the nickel oxide nanoparticles may produce a nickel surface coating, such as a pattern of nickel oxide on the surface of the substrate (e.g., the nickel-containing areas remaining after void areas are produced by ablation of certain areas of the nickel oxide nanoparticles). Stated another way, ablation of the nickel oxide nanoparticles may produce void areas in the layer of nickel oxide nanoparticles as described above, where the unablated areas form a predetermined pattern of nickel oxide on the surface of the substrate as described herein. For example, ablation of the nickel oxide nanoparticles may produce a grid pattern composed of nickel oxide on the surface of the substrate.

In certain embodiments, ablation of the nickel oxide nanoparticles is produced by applying a laser, such as a pulsed laser, to the nickel oxide nanoparticles. In certain cases, the pulsed laser has a pulse duration in the nanosecond range (i.e., a nanosecond laser). For instance, the pulse duration of the nanosecond laser may range from 1 ns to 1000 ns, such as from 1 ns to 900 ns, or from 1 ns to 800 ns, or 1 ns to 700 ns, or 1 ns, to 600 ns, or 1 ns to 500 ns, or 1 ns to 400 ns, or 1 ns to 300 ns, or 1 ns to 200 ns, or 1 ns to 100 ns, or 1 ns to 90 ns, or 1 ns to 80 ns, or 1 ns to 70 ns, or 1 ns to 60 ns, or 1 ns to 50 ns, or 1 ns to 40 ns, or 1 ns to 30 ns, or 1 ns to 20 ns, or 1 ns to 10 ns. In certain instances, the nanosecond laser has a pulse duration of 20 ns. In certain embodiments, the nanosecond laser has a pulse repetition rate ranging from 1 kHz to 500 kHz, such as 1 kHz to 400 kHz, or 1 kHz to 300 kHz, or 1 kHz to 200 kHz, or 1 kHz to 100 kHz, or 1 kHz to 90 kHz, or 1 kHz to 80 kHz, or 1 kHz to 70 kHz, or 1 kHz to 60 kHz, or 1 kHz to 50 kHz, or 1 kHz to 40 kHz, or 1 kHz to 30 kHz, or 1 kHz to 20 kHz, or 1 kHz to 10 kHz. In certain instances, the nanosecond laser has a pulse repetition rate of 20 kHz. In certain embodiments, the nanosecond laser has a wavelength of 355 nm.

In certain embodiments, ablation of the nickel oxide nanoparticles is produce by applying a pulsed laser, such as a femtosecond laser, to the nickel oxide nanoparticles (e.g., a pulsed laser with a pulse duration in the femtosecond range. For instance, the pulse duration of the femtosecond laser may range from 1 fs to 1000 fs, such as from 1 fs to 900 fs, or from 1 fs to 800 fs, or 1 fs to 700 fs, or 1 fs, to 600 fs, or 1 fs to 500 fs, or 1 fs to 400 fs, or 1 fs to 300 fs, or 1 fs to 200 fs, or 1 fs to 100 fs, or 1 fs to 50 fs, or 1 fs to 10 fs. In some instances, the pulse duration of the femtosecond laser ranges from 1 fs to 1000 fs, such as 100 fs to 900 fs, or 200 fs to 800 fs, or 300 fs to 700 fs, or 400 fs to 600 fs, such as for example, a pulse duration of 500 fs. In certain embodiments, the femtosecond laser has a pulse repetition rate ranging from 100 kHz to 50 MHz, such as 200 kHz to 40 MHz, or 300 kHz to 30 MHz, or 400 kHz to 20 MHz, or 500 kHz to 10 MHz, or 600 kHz to 7 MHz, or 700 kHz to 5 MHz, or 800 kHz to 3 MHz, or 900 kHz to 2 MHz. In certain instances, the femtosecond laser has a pulse repetition rate of 1 MHz. In certain embodiments, the femtosecond laser has a wavelength of 522 nm.

In certain embodiments, the method for producing a nickel-containing surface coating is performed under standard ambient conditions. For example, the method may be performed at standard ambient pressure (e.g., 1 atm). In these embodiments, the method may be performed without applying a vacuum to the substrate. Stated another way, the reduction annealing process and/or ablation process does not require a reduction in ambient pressure significantly below standard ambient pressure (e.g., 1 atm). In certain embodiments, the method for producing a nickel-containing surface coating is performed in a standard atmospheric environment. For example, the reduction annealing process and/or ablation process may be performed while the substrate is exposed to the standard atmospheric environment. In these embodiments, the method may be performed without providing an inert gas environment (e.g., Ar, N₂, and the like) around the substrate.

In certain embodiments, the method for producing a nickel-containing surface coating is performed in the solution phase (i.e., liquid phase). For example, the method for producing the nickel oxide nanoparticles may be performed in solution (i.e., in a liquid) as described herein. Similarly, the method for producing a nickel-containing surface coating may be performed by reduction annealing and/or ablation of the layer of the liquid composition that includes nickel oxide nanoparticles on the surface of a substrate as described herein. As such, the method for producing a nickel-containing surface coating does not require non-solution phase deposition processes (i.e., a non-liquid phase deposition process), such as chemical layer deposition or physical layer deposition processes.

### Compositions and Devices

Aspects of the present disclosure include compositions and devices produced using the methods disclosed herein. For example, as described above, methods for producing a liquid composition that includes nickel oxide nanoparticles are provided. As such, aspects of the present disclosure include a liquid composition that includes nickel oxide nanoparticles. In certain embodiments, the liquid composition that includes nickel oxide nanoparticles includes nickel oxide nanoparticles dispersed in a liquid. In certain instances, the liquid is a liquid that is compatible with the nickel oxide nanoparticles and is also compatible with subsequent reactions and/or processing that use the nickel oxide nanoparticles. For example, the liquid may be a liquid that is compatible with the substrate the liquid composition that includes nickel oxide nanoparticles is applied to and compatible with the application method, such as spin-coating, printing (e.g., inkjet printing), imprinting (e.g., soft imprinting), and the like. In some embodiments, the liquid is an organic liquid. In certain embodiments, the liquid composition that includes nickel oxide nanoparticles includes a liquid, such as a non-polar organic liquid (e.g., toluene). In some instances, the liquid composition that includes nickel oxide nanoparticles does not include hexane. In certain embodiments, the liquid composition that includes nickel oxide nanoparticles includes a polar organic liquid, such as α-terpineol (i.e., alpha-terpineol). In some instances, the liquid composition that includes nickel oxide nanoparticles may be referred to as an “ink”, a “nickel oxide ink” or a “NiO ink”.

As described above, methods for producing a nickel-containing surface coating are provided. As such, aspects of the present disclosure include a nickel-containing surface coating. The nickel-containing surface coating may include a thin layer of a liquid composition that includes nickel oxide nanoparticles as described above. In some instances, the nickel-containing surface coating has a thickness in the nanoscale range, such as 500 nm or less, 400 nm or less, 300 nm or less, 200 nm or less, 100 nm or less, 90 nm or less, 80 nm or less, 70 nm or less, 60 nm or less, 50 nm or less, 40 nm or less, 30 nm or less, 20 nm or less, or 10 nm or less. For instance, nickel-containing surface coating may have a thickness ranging from 1 nm to 100 nm, such as from 5 nm to 90 nm, or 5 nm to 80 nm, or 5 nm to 70 nm, or 5 nm to 60 nm, or 5 nm to 50 nm, or 10 nm to 50 nm, or 20 nm to 50 nm, or 20 nm to 40 nm, or 30 nm to 40 nm. In certain instances, the thickness of the nickel-containing surface coating ranges from 20 nm to 50 nm.

In addition, aspects of the present disclosure further include a substrate supporting the nickel-containing surface coating. In some instances, the substrate may be a substantially rigid substrate, e.g., a substrate that does not significantly bend when a pressure is applied to the substrate. For example, the substrate may be composed of glass, such as soda lime glass. In certain embodiments, the substrate onto which the liquid composition that includes nickel oxide nanoparticles is deposited is a flexible substrate. In these embodiments, the substrate may bend (e.g., bend without breaking) when a pressure is applied to the substrate (see FIG. 16 (panel b) and FIG. 16 (panel c)). For instance, the substrate may be composed of a flexible material, such as, but not limited, to a plastic (e.g., polyimide, polyethylene terephthalate (PET), etc.), and the like.

In certain embodiments, the nickel-containing surface coating on the surface of the substrate is a patterned surface coating as described herein. For example, the nickel-containing surface coating may be arranged in a grid pattern. In some instances, the nickel-containing surface coating may be composed of nickel, such as after being exposed to a reduction annealing process as described herein. In certain cases, the nickel surface coating may be a patterned nickel surface coating, such as a grid pattern composed of nickel. In certain embodiments, the grid pattern has a pitch ranging from 1 μm to 1000 μm, such as from 1 μm to 900 μm, or 1 μm to 800 μm, or 1 μm to 700 μm, or 1 μm to 600 μm, or 1 μm to 500 μm, or 1 μm to 450 μm, or 1 μm to 400 μm, or 1 μm to 350 μm, or 1 μm to 300 μm, or 1 μm to 250 μm, or 1 μm to 200 μm, or 1 μm to 150 μm, or 1 μm to 100 μm, or 5 μm to 100 μm, or 10 μm to 100 μm, or 10 μm to 90 μm, or 10 μm to 80 μm, or 10 μm to 70 μm, or 10 μm to 60 μm, or 10 μm to 50 μm, or 10 μm to 40 μm, or 10 μm to 30 μm. In some cases, the grid has a pitch of 10 μm. In some cases, the grid has a pitch of 20 μm. In some cases, the grid has a pitch of 40 μm. In some cases, the grid has a pitch of 60 μm. In some cases, the grid has a pitch of 80 μm. In some cases, the grid has a pitch of 100 μm. In some cases, the grid has a pitch of 120 μm. In some cases, the grid has a pitch of 140 μm. In some cases, the grid has a pitch of 160 μm. In some cases, the grid has a pitch of 180 μm. In some cases, the grid has a pitch of 200 μm. In some cases, the grid has a pitch of 500 μm.

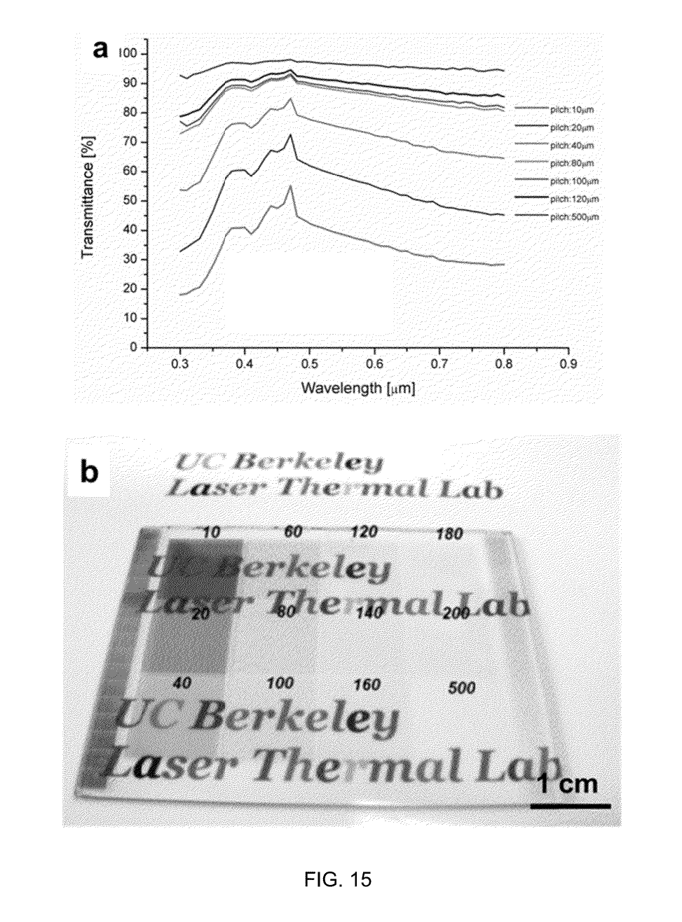

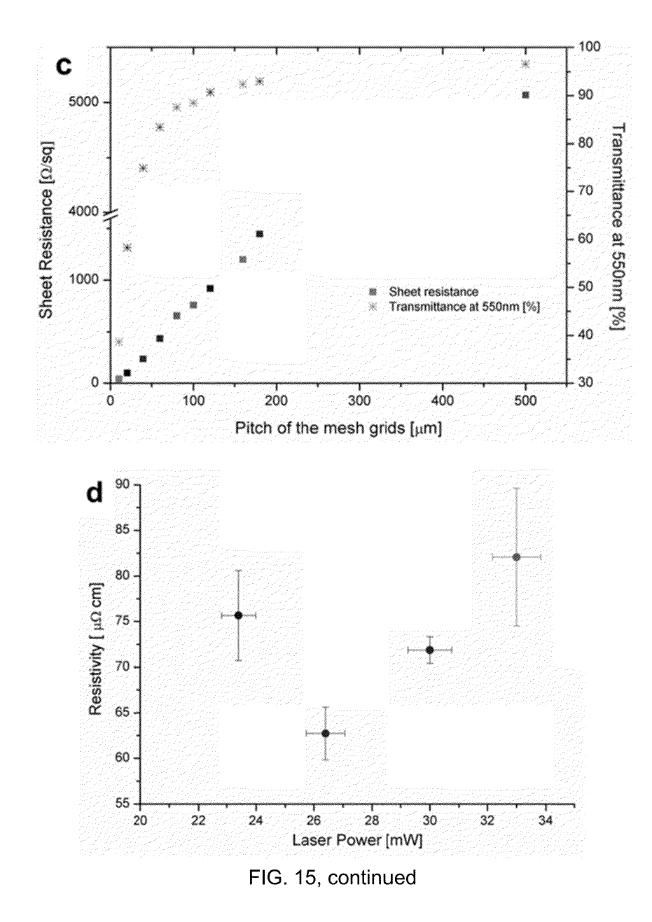

In certain embodiments, the substrate is substantially transparent, such that substantially all of incident light on the substrate is transmitted through the substrate. As described above, a patterned (e.g., grid patterned) nickel-containing surface coating may be disposed on the surface of the substrate. In these embodiments, the amount of light transmitted through the substrate may depend on the pitch of the grid pattern disposed on the surface of the substrate. For instance, a grid having a larger pitch may have a greater transmission of light through the substrate. Conversely, a grid having a smaller pitch may have a lower transmission of light through the substrate. In certain embodiments, the transmittance of light through the substrate may range from 10% to 99%, such as from 10% to 97%, or from 10% to 95%, or from 20% to 90%, or from 30% to 90%, or from 40% to 90%, or from 50% to 90%, or from 60% to 90%, or from 70% to 90%, or from 80% to 90%. For example, a grid having a pitch of 80 μm may have a transmittance of 87% at 550 nm wavelength of light (see FIG. 15 (panel c)).

In certain embodiments, the nickel-containing surface coating is an electrode. As described above, the nickel-containing surface coating may be reduced and annealed to form a nickel surface coating. In some instances, the nickel surface coating is used as an electrode. In certain cases, the nickel surface coating may be patterned, such as a nickel grid pattern as described above. In certain embodiments, the nickel electrode has a resistance (sheet resistance) ranging from 1 Ω/sq to 5000 Ω/sq, such as from 1 Ω/sq to 4500 Ω/sq, or from 1 Ω/sq to 4000 Ω/sq, or from 1 Ω/sq to 3500 Ω/sq, or from 1 Ω/sq to 3000 Ω/sq, or from 1 Ω/sq to 2500 Ω/sq, or from 1 Ω/sq to 2000 Ω/sq, or from 1 Ω/sq to 1500 Ω/sq, or from 1 Ω/sq to 1000 Ω/sq, or from 1 Ω/sq to 900 Ω/sq, or from 1 Ω/sq to 800 Ω/sq, or from 1 Ω/sq to 700 Ω/sq, or from 1 Ω/sq to 600 Ω/sq, or from 1 Ω/sq to 500 Ω/sq, or from 1 Ω/sq to 400 Ω/sq, or from 1 Ω/sq to 300 Ω/sq, or from 1 Ω/sq to 200 Ω/sq, or from 1 Ω/sq to 100 Ω/sq, or from 1 Ω/sq to 75 Ω/sq, or from 1 Ω/sq to 50 Ω/sq, or from 1 Ω/sq to 25 Ω/sq, or from 1 Ω/sq to 10 Ω/sq. In certain embodiments, the nickel electrode has a resistance (sheet resistance) ranging from 1 Ω/sq to 1000 Ω/sq, such as from 10 Ω/sq to 1000 Ω/sq, or from 100 Ω/sq to 1000 Ω/sq, or from 200 Ω/sq to 900 Ω/sq, or from 300 106 /sq to 800 Ω/sq, or from 400 Ω/sq to 700 Ω/sq, or from 500 Ω/sq to 700 Ω/sq, or from 600 Ω/sq to 700 Ω/sq. For example, a nickel electrode having a grid pattern with a pitch of 80 μm may have a resistance (sheet resistance) of 655 Ω/sq.

In certain embodiments, a nickel-containing electrode, such as a nickel electrode as provided herein, is included as part of a device that uses electrodes (e.g., nickel electrodes). For example, a nickel electrode on a transparent substrate as described herein (e.g., a nickel electrode having a grid pattern) may be included as part of a transparent conductive panel. Such transparent conductive panels may be used in devices, such as, but not limited to, a touchscreen panel in a touchscreen device. Nickel electrodes may also be included in other types of devices that use nickel electrodes, such as, but not limited to, sensors, batteries, electrochemical cells, solar cells, and the like.

### Utility

The subject methods and devices and find use in a variety of different applications where the production and use of liquid compositions that include nickel oxide (NiO), such as nickel oxide nanoparticles, is desired. For example, the subject methods find use in the production of nickel oxide nanoparticles and liquid compositions containing nickel oxide nanoparticles. The subject methods and liquid compositions of nickel oxide nanoparticles find use in the production of nickel oxide (NiO) thin films, such as thin films of nickel oxide nanoparticles on a surface of a substrate. In certain instances, the nickel oxide thin films find use in one or more of the following applications: solution-processible electrode fabrication (as described herein); NiO thin films used to fabricate nickel electrodes by reductive sintering (as described herein); semiconducting thin film for optoelectronic devices, e.g., as described in U.S. Pat. Nos. 8,779,413, 8,723,211, 8,576,400, 8,288,787, 7,767,982, and the like; transparent electrodes including for applications such as touch screen panels, e.g., as described in U.S. Pat. Nos. 8,773,628, 8,648,525, 8,029,886, 7,843,123, 7,787,089, 7,314,673, 7,250,930, and the like; electrodes for flexible electronics, e.g., as described in U.S. Pat. Nos. 8,766,532, 8,600,082, 8,451,249, 7,733,560, 7,593,086, and the like; electrodes for chemical sensors, e.g., as described in U.S. Pat. Nos. 8,736,000, 8,384,409, 7,540,948, 6,487,326, 6,165,336, and the like; electrodes for physical sensors, e.g., as described in U.S. Pat. Nos. 8,736,582, 8,033,185, 7,758,979, 6,958,565, 6,388,300, and the like; electrodes for solar cells, e.g., as described in U.S. Pat. Nos. 8,754,325, 8,648,251, 8,138,009, 7,732,229, 6,201,261, and the like; wire grid polarizers, e.g., as described in U.S. Pat. Nos. 8,730,575, 8,698,982, 8,611,007, 8,027,087, 7,638,796, and the like; and the like.

In addition, the subject NiO liquid compositions and NiO thin films find use in the production of nickel oxide and/or nickel patterns on the surface of a substrate. For instance, the NiO liquid compositions and NiO thin films find use in the production of nickel oxide patterns on the surface of a substrate by laser ablation of a NiO thin film as described herein. The NiO liquid compositions and NiO thin films also find use in the production of nickel patterns on the surface of a substrate, for example by reductive sintering of a NiO thin film using a laser (e.g., a continuous wave laser) as described herein. The NiO liquid compositions also find use in the production of nickel patterns on the surface of a substrate using a combination of imprinting (e.g., soft imprinting) of a NiO nanoparticle liquid composition on the surface of a substrate and subsequent laser reduction and annealing.

The subject NiO liquid compositions and NiO thin films also find use in the production of nickel patterns on the surface of a substrate, such as patterned nickel electrodes. In some embodiments, the subject NiO liquid compositions and thin films find use in the production of nickel grid electrodes on the surface of a substrate (e.g., a substantially transparent substrate). As such, the subject NiO liquid compositions and thin films find use in the production of transparent conductive panels, which may be used in devices, such as, but not limited to, a touchscreen panel in a touchscreen device, e.g., as described in U.S. Pat. Nos. 8,748,749, 8,388,127, 8,049,333, 7,750,555, 7,247,568, and the like.

The subject methods and devices find use in applications that benefit from the use of corrosion resistant electrodes. In some instances, the subject nickel electrodes are corrosion resistant, and as such are suitable for use in corrosive environments where the electrodes are exposed to corrosive gases and/or liquids. For example, the subject nickel electrodes find use as electrodes in batteries and electrochemical cells where the electrodes may be exposed to corrosive gases and/or liquids.

### Systems

Aspects of the present disclosure include systems for producing a nickel-containing surface coating as described herein. For example, systems for producing a nickel-containing surface coating may include a system configured for contacting a surface of a substrate with a liquid composition that includes nickel oxide nanoparticles. In certain instances, the system includes a system configured for performing a liquid deposition technique, such as, but not limited to, spin-coating, dip coating, printing, imprinting, combinations thereof, and the like. In some instances, the system includes a spin-coating device configured to deposit a liquid composition on a surface of a substrate and produce a thin layer of the liquid composition on the surface of the substrate by spinning the substrate. In some instances, the system includes a printing device configured to deposit a liquid composition on a surface of a substrate by printing the liquid composition on the surface of the substrate. In some instances, the system includes a dip coating device configured to contact a liquid composition to a surface of a substrate and produce a thin layer of the liquid composition on the surface of the substrate by dipping the substrate into the liquid composition. In some instances, the system includes an imprinting device configured to deposit a liquid composition on a surface of a substrate and produce a thin layer of the liquid composition on the surface of the substrate by imprinting the liquid composition onto a surface of the substrate. In certain cases, the liquid composition is a liquid composition that includes nickel oxide nanoparticles (e.g., a NiO ink) as described herein.

Systems of the present disclosure may further include a device configured for modifying the nickel oxide nanoparticles on the surface of the substrate. For example, the device for modifying the nickel oxide nanoparticles on the surface of the substrate may include a laser. In some cases, the laser is configured to perform a reduction annealing process on the nickel oxide nanoparticles. In these instances, the laser may be a continuous wave laser as described herein. In some cases, the laser is configured to perform an ablation process on the nickel oxide nanoparticles. In these instances, the laser may be a pulsed laser as described herein.

In certain embodiments, the system includes a substrate holder configured to hold the substrate (e.g., a substrate with a thin layer of nickel oxide nanoparticles on its surface, as described herein) in the path of the laser. In some embodiments, the substrate holder is configured to move the substrate along one or more axes of movement relative to the focal point of the laser. For instance, the substrate holder may include one or more actuators configured to translate the substrate along one or more axes of movement, such as an x-axis, y-axis, and/or z-axis. Systems that include a movable substrate holder may facilitate the production of patterns (e.g., grid patterns) of NiO and/or Ni on the surface of the substrate, as described herein.

### Kits

Aspects of the present disclosure additionally include kits that include a liquid composition that includes nickel oxide nanoparticles as described in detail herein. The kits may further include a liquid. For instance, the kit may include a liquid, such as an organic liquid. In some instances, the organic liquid includes toluene, alpha-terpineol, and the like.

In addition to the above components, the subject kits may further include instructions for practicing the subject methods. These instructions may be present in the subject kits in a variety of forms, one or more of which may be present in the kit. One form in which these instructions may be present is as printed information on a suitable medium or substrate, e.g., a piece or pieces of paper on which the information is printed, in the packaging of the kit, in a package insert, etc. Another form would be a computer readable medium, e.g., CD, DVD, Blu-Ray, computer-readable memory (e.g., flash memory), etc., on which the information has been recorded or stored. Yet another form that may be present is a website address which may be used via the Internet to access the information at a removed site. Any convenient means may be present in the kits.

As can be appreciated from the disclosure provided above, embodiments of the present invention have a wide variety of applications. Accordingly, the examples presented herein are offered for illustration purposes and are not intended to be construed as a limitation on the invention in any way. Those of ordinary skill in the art will readily recognize a variety of noncritical parameters that could be changed or modified to yield essentially similar results. Thus, the following examples are put forth so as to provide those of ordinary skill in the art with a complete disclosure and description of how to make and use the present invention, and are not intended to limit the scope of what the inventors regard as their invention nor are they intended to represent that the experiments below are all or the only experiments performed. Efforts have been made to ensure accuracy with respect to numbers used (e.g. amounts, temperature, etc.) but some experimental errors and deviations should be accounted for. Unless indicated otherwise, parts are parts by mass, molecular mass is mass average molecular mass, temperature is in degrees Celsius, and pressure is at or near atmospheric.

### EXAMPLES

### Example 1

### Summary

This example concerns the production of nickel oxide (NiO) nanoparticle liquid composition for a variety of applications. The experiments demonstrated a new method for producing NiO nanoparticle liquid composition that was performed under ambient conditions. NiO nanoparticles were generated from nickel(II) acetylacetonate (CAS number: 3264-82-2) in oleylamine (CAS number: 112-90-3) and oleic acid (CAS number: 112-80-1) solution reduced by borane-triethylamine complex (CAS number: 1722-26-5). Measured mean particle diameter was approximately 2 to 5 nm. After adding ethanol, NiO nanoparticles were collected in centrifuge tubes, and then dispersed in various liquids, such as toluene (CAS number: 108-88-3) and alpha-terpineol (CAS number: 98-55-5). This method produced high quality, concentration-tunable, NiO nanoparticle liquid composition. Also, the NiO nanoparticle liquid composition formed a thin film with fine morphology by spin coating.

Experiments were performed for the purpose of developing a laser process to fabricate a nickel electrode pattern by reduction annealing. Nickel oxide nanoparticles were synthesized. Small diameter NiO nanoparticles were fabricated without an inert environment. A borane-triethylamine complex was used as a reducing agent. The synthesis was performed at ambient conditions without an inert gas environment. The nanoparticles were washed with ethanol to remove residual chemicals. The washing process facilitated thin film formation. The nanoparticles were dispersed better in toluene or alpha-terpineol than in hexane. In some instances, the film quality depended on the nanoparticle liquid. The synthesized nanoparticle liquid composition was used to fabricate a thin film.

### Experimental Details

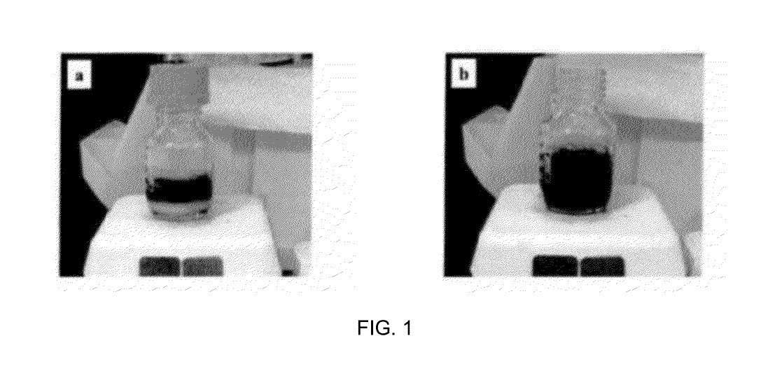

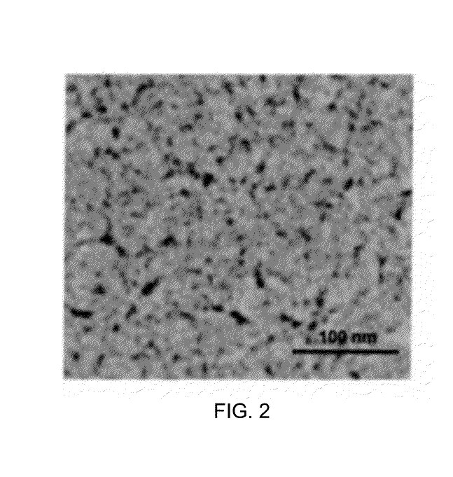

Under ambient conditions, 0.257 g of nickel(II) acetylacetonate (CAS number: 3264-82-2) was mixed with 15 ml of oleylamine (CAS number: 112-90-3) mixed with 0.32 ml of oleic acid (CAS number: 112-80-1) followed by maintaining the solution at 110° C. over 1 hour with vigorous stirring. The resultant solution appeared dark-green as shown in FIG. 1 (panel a). The solution was cooled down and kept at 90° C., and then 0.339 ml of borane-triethylamine complex (CAS number: 1722-26-5) mixed with 2 ml of oleylamine (CAS number: 112-90-3) was quickly injected into the solution. Within a few seconds, the solution color changed from dark green to dark-brown or black as shown in FIG. 1 (panel b). The resultant solution was kept at 90° C. for 1 h with vigorous stirring and cooled down to room temperature. To collect the NiO nanoparticles from the solution, 30 ml of ethanol was added to the solution, and the mixture was then centrifuged at 3000-4000 rpm for 15 min. To remove the residual solvents, the nanoparticles were washed with ethanol several times (three times or more) by repeated addition of ethanol and centrifuging. The size of the NiO nanoparticle was estimated to be 2-5 nm as shown in FIG. 2. The synthesis procedure was scalable.

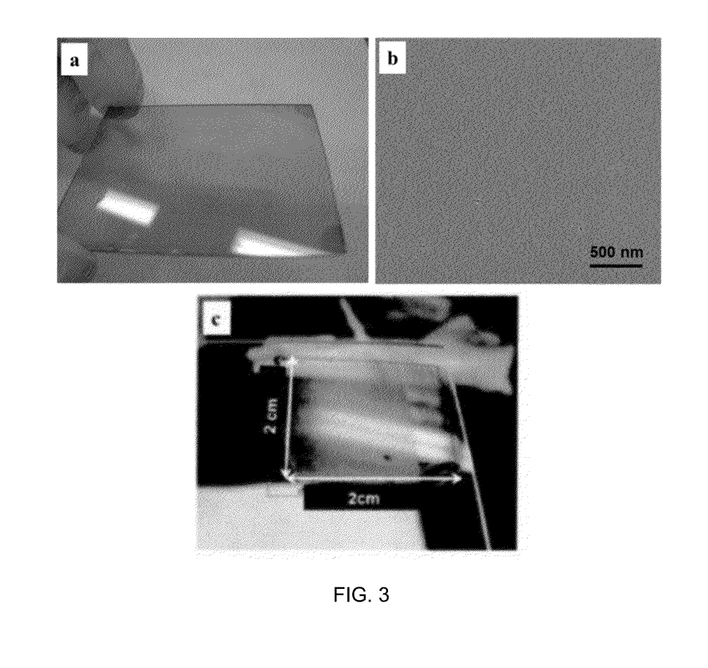

The collected nanoparticles were dispersed in various liquids such as toluene (CAS number: 108-88-3) and alpha-terpineol (CAS number: 98-55-5). NiO nanoparticles dispersed in toluene formed a high quality thin film by spin coating on an oxygen-plasma-treated glass substrate as shown in photoimage and SEM image (FIG. 3 (panel a) and FIG. 3 (panel b)). A liquid composition of NiO nanoparticles in alpha-terpineol were utilized as an ink for soft imprinting method (FIG. 3 (panel c)) using a polydimethylsiloxane stamp. In some cases, a NiO thin film may be deposited by dip coating or ink jet printing of the NiO liquid composition on a substrate.

### Results

The synthesized NiO nanoparticles were very small and the size was uniform. The nanoparticles were well-dispersed in the liquid to form a high concentration, high quality NiO nanoparticle liquid composition (e.g., NiO ink). The maximum temperature during the synthesis was 110° C. and the synthesis did not require an inert environment. The NiO nanoparticle liquid composition enabled the fabrication of a solution-processed NiO thin film with fine morphology. No vacuum chamber and no expensive equipment was required and the nanoparticle liquid composition was used to deposit a large area NiO thin film rapidly. The nanoparticle liquid composition concentration was adjustable and the thin film thickness was controlled by adjusting the concentration of the liquid composition and/or the coating parameters.

### Example 2

### Summary

Experiments were performed for the production of Ni patterns through reduction annealing and/or ablation of solution-processed NiO thin film by laser processing. The term “reduction annealing” is a process where reduction occurs substantially simultaneously during an annealing process. The experiments demonstrated a method to produce Ni patterns via a non-vacuum, lithography-free, solution-processible method that was performed under ambient conditions. The fabricated Ni electrodes by this method had high conductivity and smooth morphology. For example, thin Ni electrodes were fabricated. Continuous wave (CW) and short-pulse lasers were used on the NiO thin film to either perform reduction annealing or ablation. The experiments also demonstrated the production of Ni patterns produced using a combination of soft imprinting and laser annealing.

Experiments were performed demonstrating a solution-based Ni electrode fabrication process. A NiO thin film, which was deposited by spin coating of a NiO nanoparticle liquid composition, was annealed. The NiO thin film was annealed and reduced substantially simultaneously (e.g., reduction annealing) to form a Ni electrode using a 514.5 nm continuous wave laser. The NiO thin film was also exposed to pulse lasers. For example, the NiO thin film was ablated by a 355 nm nanosecond laser and a 522 nm femtosecond laser.

### Experimental Details

1. NiO Thin Film Fabrication by a Solution-Processible Route

A NiO film was prepared by spin coating or dip coating of a NiO nanoparticle liquid composition as described herein (see, e.g., Example 1 above) on a glass substrate. For the NiO nanoparticle liquid composition, the NiO nanoparticles had a mean diameter of about 4 to 5 nm and were dispersed in toluene or alpha-terpineol. The film surface was very smooth as seen in FIG. 3 (panel a) and FIG. 3 (panel b). No vacuum and no heating was required.

2. Laser Processing for Reduction Annealing and/or Ablation of NiO Thin Film

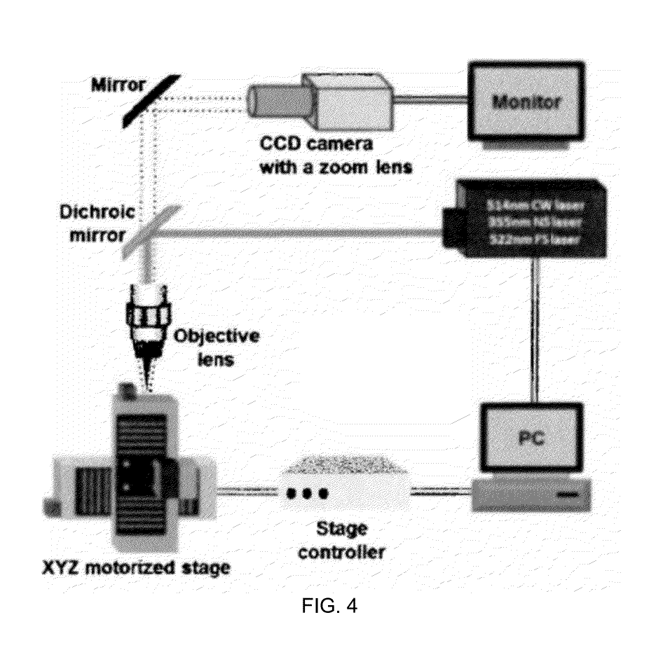

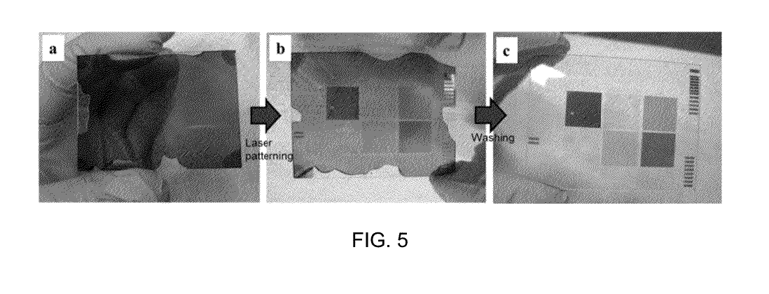

FIG. 4 shows a schematic diagram of a laser setup. The NiO film on a glass substrate (FIG. 5 (panel a)) was translated under the laser irradiation through a fixed objective lens. All the following experiments were performed under ambient conditions.

2a. NiO Reduction Annealing with a 514.5 nm Continuous Wave (CW) Laser

Fine Ni patterns were generated after NiO reduction annealing using a CW laser (FIG. 5 (panel a) and FIG. 5 (panel b)). A 514.5 nm continuous laser was used to anneal and reduce the NiO thin film on glass and poyimide. For the focused laser beam with a diameter of about 5 μm, the power used was 5 to 40 mW to generate a Ni pattern by annealing and reducing the NiO layer. The power depended on the substrate material and the thickness of the NiO film. With excessive power, the thin film was damaged and a hollow part was created from the center of the pattern. With appropriate power, fine Ni patterns were generated (FIG. 5 (panel b)). After laser processing, the un-annealed part of the NiO film was washed away with an organic liquid (FIG. 5 (panel c)). The surface of the Ni pattern appeared very smooth and shiny. The pattern transmittance depended on the pitch of the Ni patterns.

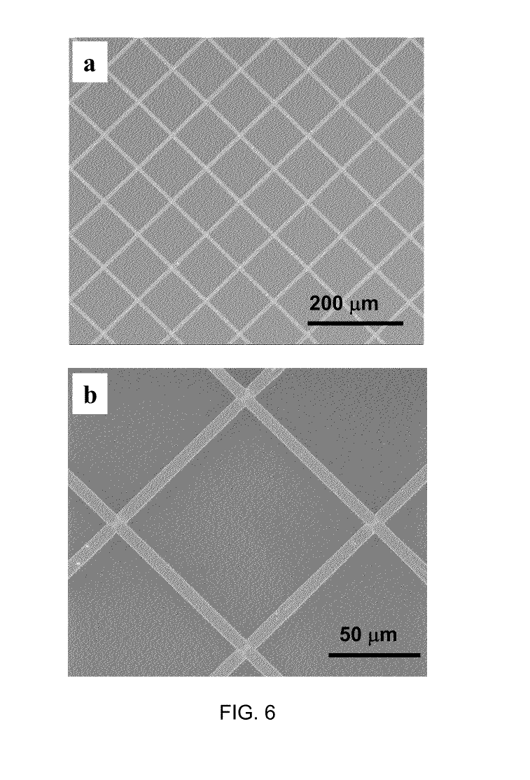

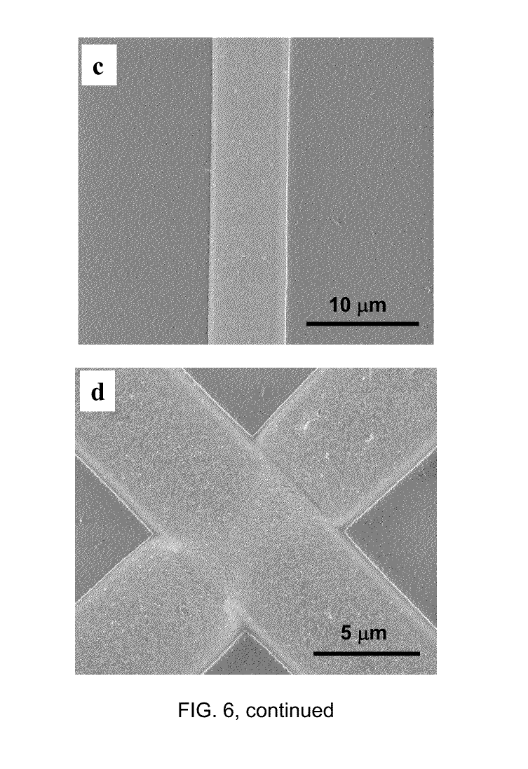

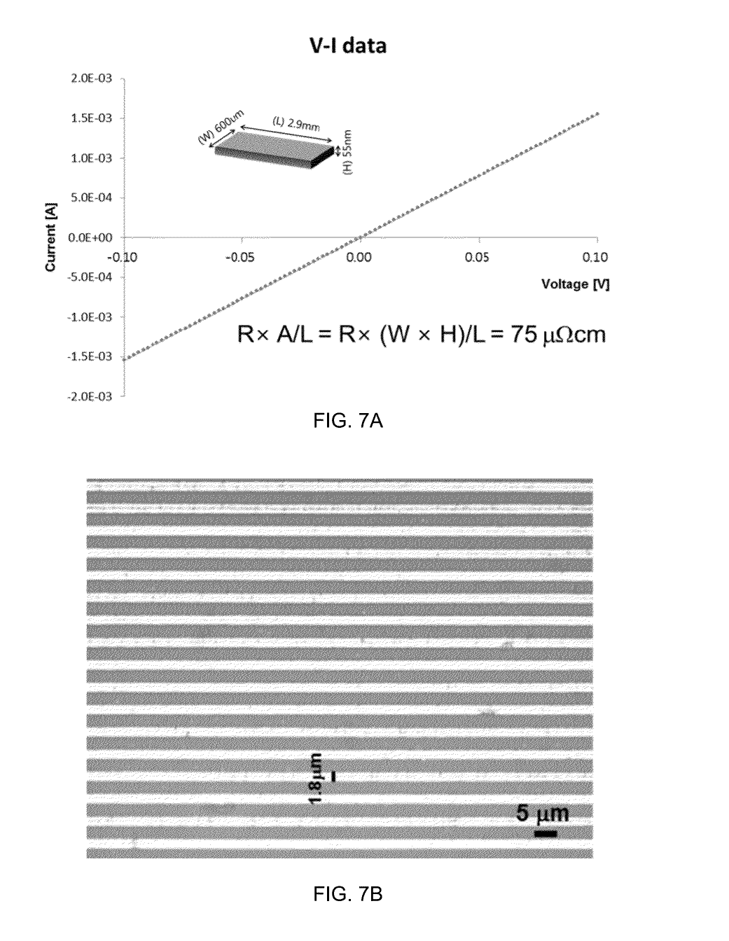

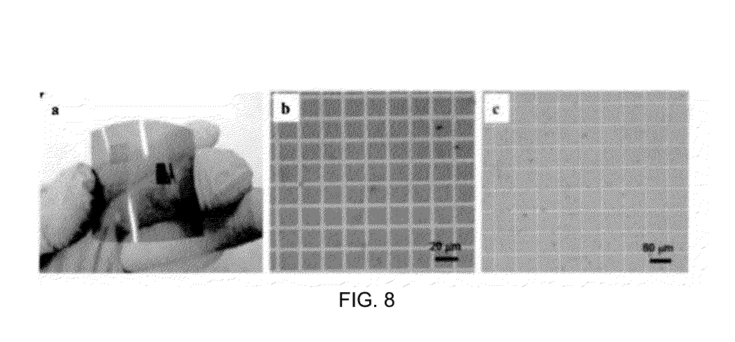

SEM images are shown in FIG. 6 (panel a) to FIG. 6 (panel d). The thickness of the pattern was measured to be about 35-40 nm by atomic force microscopy (AFM). The thickness of the pattern can be adjusted by varying the thickness of the NiO thin film. The resistivity of the laser annealed/reduced Ni pattern, which was measured using a 55 nm thickness pattern sample, was about 750 nΩ·m, as shown in FIG. 7A, which was calculated from ρ=RA/L, where R, A, and L are the resistance, cross-section and length of the measured pattern, respectively. For comparison, the resistivity of bulk Ni is 69.3 nΩ·m and that of a thin film deposited by sputtering or atomic layer deposition (ALD) is about 200 to 300 nΩ·m. Smaller Ni line patterns were created as shown in the optical image in FIG. 7B using a more tightly focused beam with higher numerical aperture (NA) lens. The laser process was applicable on a flexible substrate. FIG. 8 (panel a), FIG. 8 (panel b), and FIG. 8 (panel c) show Ni patterns generated by reduction annealing of NiO on a flexible polyimide substrate. The pattern transmittance depended on the pitch of the Ni patterns. The pattern pitch shown in FIG. 8 (panel b) was 20 μm, and the pattern pitch shown in FIG. 8 (panel c) was 80 μm.

2b. NiO Film Ablation with a 355 nm Nanosecond (NS) Laser

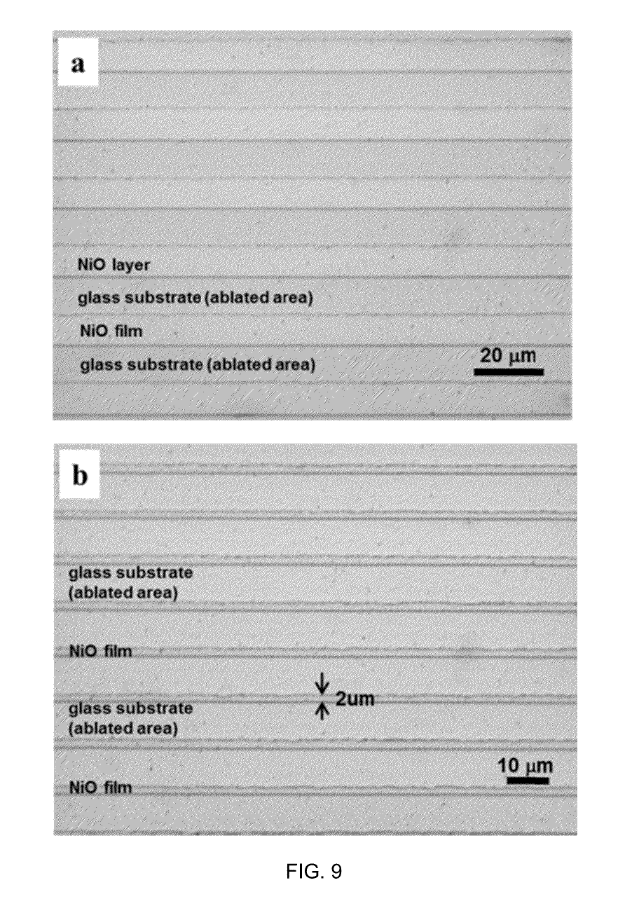

A 355 nm nanosecond laser (pulse duration: 20 ns, pulse repetition rate: 20 kHz) was used to ablate the NiO thin film on glass. The ablation process was used to pattern a NiO thin film and also used to make Ni patterns by reduction annealing of the remaining NiO layers. When the laser scan speed was 10 mm/s and the beam diameter was about 10 μm, the ablation threshold was estimated to be 5 to 15 mW. FIG. 9 (panel a) and FIG. 9 (panel b) show optical images of the ablated NiO patterns on a glass substrate by the NS laser. The ablated NiO pattern shown in FIG. 9 (panel a) had a large pitch (20 μm), and the ablated NiO pattern shown in FIG. 9 (panel b) had a small pitch (10 μm).

The ablation width was about 10 μm and the remaining pattern width was adjustable by changing the pitch of the ablation path. A narrower ablation width could be achieved by adjusting laser fluence near the threshold or with a more tightly focused laser beam. The ablation scan speed may also be increased, depending on the laser power.

2c. NiO Film Ablation with a 522 nm Femtosecond (FS) Laser

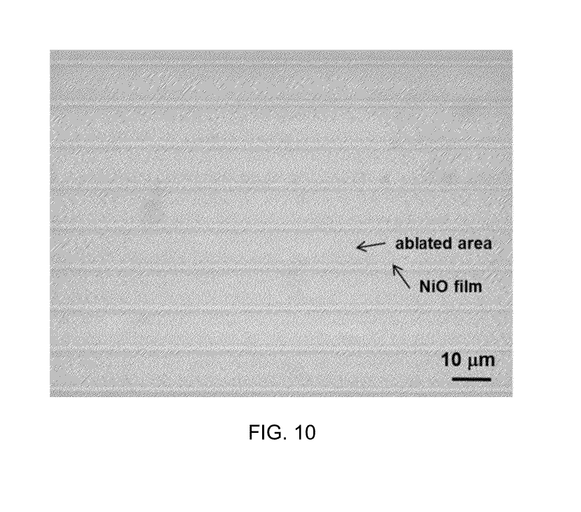

A 522 nm femtosecond laser (pulse duration: 500 fs, pulse repetition rate: 1 MHz) was used to ablate a NiO thin film on glass. When the scan speed was 10 mm/s and beam diameter was about 5 μm, the ablation threshold was estimated to be 25 to 40 mW. FIG. 10 shows optical images of the ablated NiO pattern on a glass substrate by the FS laser.

Table 1 summarizes the laser parameters for reduction annealing and/or ablation of the NiO film.

TABLE 1
Laser parameters for the NiO thin film process

| | | Pulse | Repetition | Beam | Scan | Laser | Pulse | | # of |
|---|---|---|---|---|---|---|---|---|---|
| Purpose | Wavelength | duration | rate | diameter | speed | power | energy¹ | Fluence² | pulses/spot |
| Reduction | 514.5 nm | CW | n/a | 5 μm | 10 mm/s | 5-40 mW | n/a | n/a | n/a |
| annealing | | | | | | | | | |
| Ablation | 355 nm | 20 ns | 20 kHz | 10 μm | 10 mm/s | 5-15 mW | 0.25-0.75 μJ | 0.318-0.955 J/cm² | 20 |
| Ablation | 522 nm | 500 fs | 1 MHz | 5 μm | 10 mm/s | 25-40 mW | 25-40 nJ | 0.127-0.204 J/cm² | 500 |

¹Pulse energy = (laser power)/(repetition rate)
²Fluence = (Pulse energy)/(beam spot area)
³ Number of pulses/spot = (beam diameter)/(scan speed) * (repetition rate)
n/a = not applicable

2d. Ni Patterning by Soft Imprinting Followed by Laser Annealing

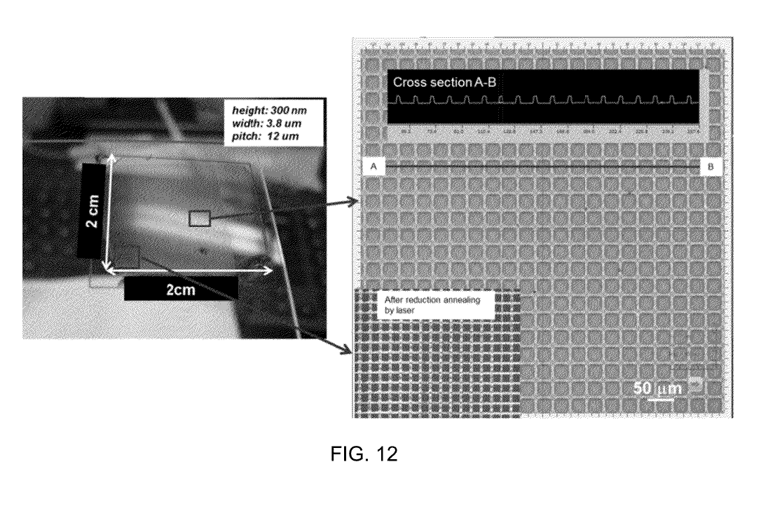

The NiO nanoparticle liquid composition was deposited and patterned through the soft imprinting lithography. FIG. 12 shows a photoimage (left) and a confocal microscope image (right) of imprinted NiO patterns. The imprinted NiO pattern was converted to a Ni pattern, as shown in FIG. 12 (right), by laser reduction annealing as described herein. Arbitrary patterns were imprinted with various types of stamps. By combining the soft imprinting method and laser annealing process, large area Ni patterns were generated via a rapid, non-vacuum, low-cost, lithography-free, solution processible route.

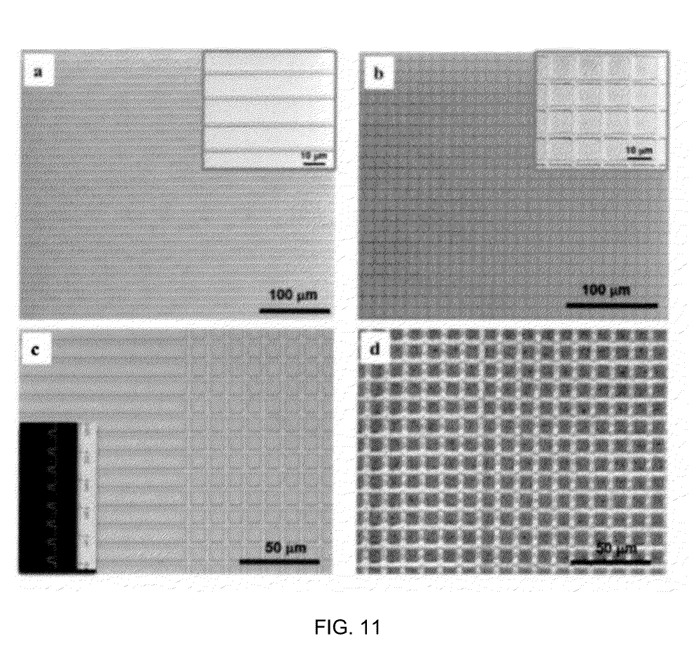

FIG. 11 (panel a) and FIG. 11 (panel b) show SEM images of imprinted NiO line and mesh patterns, respectively. FIG. 11 (panel c) shows optical images of a combination of line and mesh patterns. FIG. 11 (panel c), inset, shows a cross-section of the reliable and uniform patterns measured by a laser scanning confocal microscope. The height of the NiO pattern was about 300 nm. Arbitrary patterns can be imprinted with various types of stamps. FIG. 11 (panel d) shows Ni patterns produced by reduction annealing of NiO patterns with the laser annealing process described in Section 2a above. A combination of a soft imprinting method and laser annealing process was used to produce large area Ni patterns via a rapid, non-vacuum, low-cost, lithography-free, solution processible method, which was useful for many applications such as wire grid polarizer fabrication and optoelectronic devices.

### Example 3

### Summary

Experiments were performed to produce direct patterning of Ni electrodes through selective reduction and substantially simultaneous sintering of NiO nanoparticle (NP) ink by a laser direct writing (LDW) process. High-resolution direct patterning of Ni electrodes was performed by reduction sintering of solution-processed NiO thin film by LDW. This method was used for the fabrication of a transparent touchscreen panel. The term “reduction sintering” (or “reduction annealing”) refers to the process wherein reduction occurs just before or substantially simultaneously with the sintering process. Using this method, high resolution Ni patterns were generated from NiO NP thin films by a vacuum-free, lithography-free and solution-processible method. A continuous wave (CW) laser was used for the LDW process that included reduction and sintering the NiO metal oxide under ambient conditions. Typically, transient heat sources such as a short pulse laser beam or flash light may be needed for reducing a metal oxide into a metal under ambient conditions by removing oxygen, since metals tend to be oxidized at elevated temperatures. However, the experiments discussed herein show that a CW laser performed reduction sintering of the NiO metal oxide under ambient conditions, which was facilitated with the use of reducing agents in the liquid of the NP ink. The Ni electrodes fabricated by this method have high conductivity and smooth morphology, showing glossy metallic surfaces due to specular reflection from the smooth surface.

The resulting thin (˜40 nm) Ni electrodes had glossy metallic surfaces with smooth morphology and well-defined edges. The transmittance and conductance of the fabricated thin electrodes were sufficiently high enough to be applied to transparent touchscreen panels. A high-transmittance (>87%), electrically conducting panel for a touchscreen panel application was produced. The resistivity of the Ni electrode was less than an order of magnitude higher compared to that of the bulk Ni. Mechanical bending tests, tape-pull tests and ultrasonic-bath tests confirmed that the electrodes adhered well on glass and polymer substrates. The CW laser reduction sintering was also used to produce Ni patterns on a plastic substrate due to the minimized thermal effect on the substrate during laser processing. The combination of NP ink deposition and LDW was used to perform high-resolution, direct patterning of electrodes on various types of substrates without inflicting thermal damage.

### NiO Nanoparticle Preparation

All chemicals were purchased from Sigma Aldrich. Under ambient conditions, 0.257 g of nickel(II) acetylacetonate (C₁₀H₁₄NiO₄) and 0.32 ml of oleic acid (C₁₈H₃₄O₂) was dissolved in 15 ml of oleylamine (C₁₈H₃₇N) and heated to 110° C. with vigorous stirring. The solution was kept at 110° C. for more than 1 h to degas dissolved oxygen and evaporate moisture. The solution was cooled down and kept at 90° C., and then 0.339 ml of borane-triethylamine complex ((C₂H₅)₃N.BH₃) mixed with 2 ml of oleylamine was injected into the solution. The produced solution was kept at 90° C. for 1 h with vigorous stirring and cooled down to room temperature. To collect the NiO NPs from the solution, 30 ml of ethanol (C₂H₆O) was added to the solution, and the mixture was then centrifuged at 3000-4000 rpm for 15 min. After removing the residual solvents, the NiO nanoparticles were further washed with ethanol several times. The collected NPs were dispersed in toluene (C₇H₈) or alpha-terpineol (C₁₀H₁₈O) by sonication.

### Results and Discussion

The NiO NPs were synthesized as described above. The NiO NP synthesis process did not require inert environment, and the entire process flow from the materials synthesis to the laser process for Ni electrode fabrication was performed under ambient conditions.

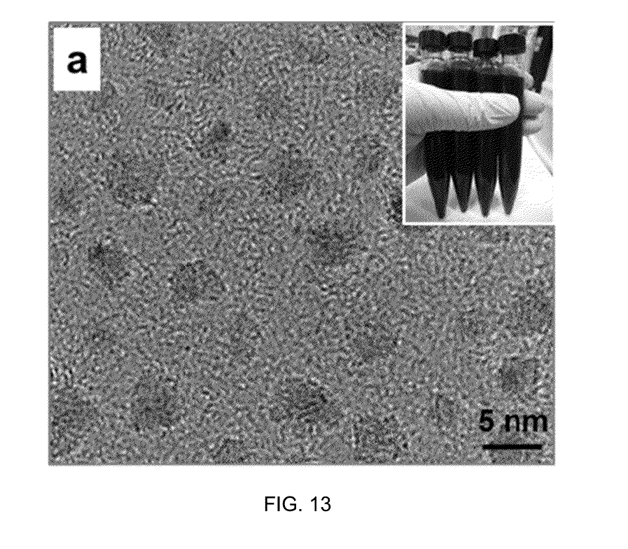

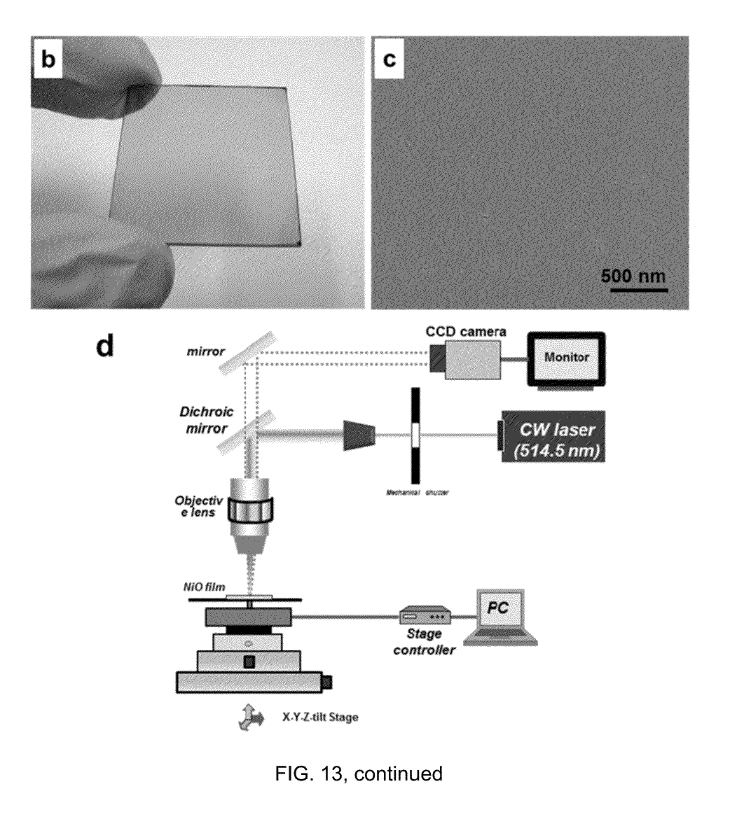

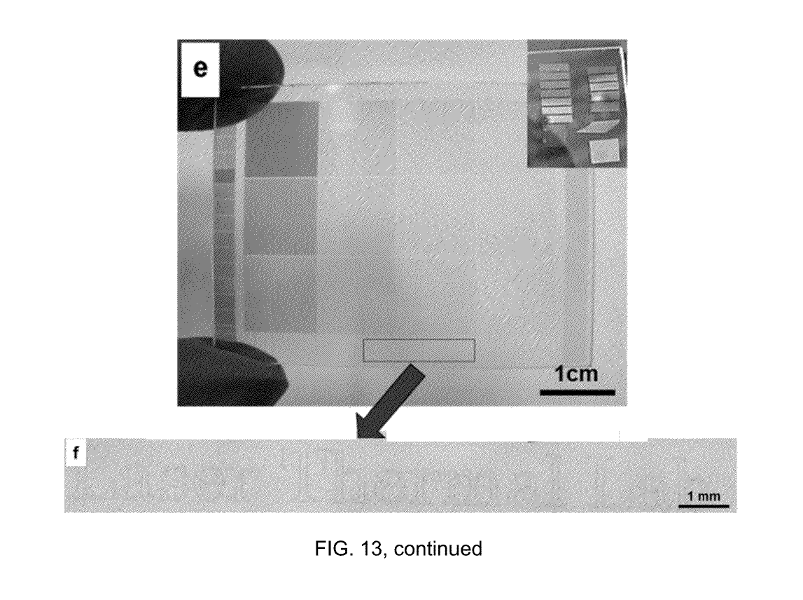

The size of synthesized NiO NP was 2-3 nm with uniform distribution as verified by TEM (FIG. 13 (panel a)). The synthesized NPs were well-dispersed in various liquids, including toluene (C₇H₈) and alpha-terpineol (C₁₀H₁₈O) without agglomeration (FIG. 13 (panel a, inset), so that high quality thin films were deposited by spin coating on an oxygen-plasma-treated soda-lime glass substrate, as shown in optical microscope and scanning electron microscope (SEM) images (FIG. 13 (panel b) and FIG. 13 (panel c)). It was also possible to deposit NiO thin films by dip coating or ink jet printing of the NiO NP ink liquid composition. The NP concentration and solid content in the ink were easily adjustable. The thin film thickness was controlled by varying the ink concentration or the spin coating process parameters. For these examples, the concentration of NiO NP in the ink and the spin speed were fixed at 1.1% by weight and 2000 rpm, respectively, which produced uniform samples. The NiO NPs were stable over at least two weeks.

The prepared film was processed by a laser direct writing (LDW) process (e.g., direct exposure of the NiO NP thin film to a laser) to perform reduction sintering. A 514.5 nm continuous wave (CW) laser beam was used with a Gaussian beam profile of 4.6 μm (1/e²) diameter obtained through a 10× infinite-corrected objective lens. FIG. 13 (panel d) shows a schematic illustration of the LDW setup. The laser power was adjusted to produce reduction sintered electrodes at a fixed scanning speed of 10 mm/s. The optimum power was about 10-27 mW, which was dependent on the substrate type. After the LDW, the un-sintered parts of the thin film were washed away with the same liquid as used in the NiO NP liquid composition (e.g., toluene or alpha-terpineol). The sintered parts adhered to the substrate. FIG. 13 (panel e) shows mesh-type Ni electrode patterns defined on a glass substrate by laser scanning in two orthogonal directions. The laser-irradiated part of the NiO film was reduced and sintered into a shiny and conductive Ni mesh pattern. The inset of the FIG. 13 (panel e) shows glossy surfaces of a plane-type Ni electrode under illumination which showed specular reflection due to a smooth and uniform surface topography. The LDW process was also coupled to a CAD (computer aided design) system, which facilitated a one-step arbitrary patterning of the NiO thin film (FIG. 13 (panel f)).

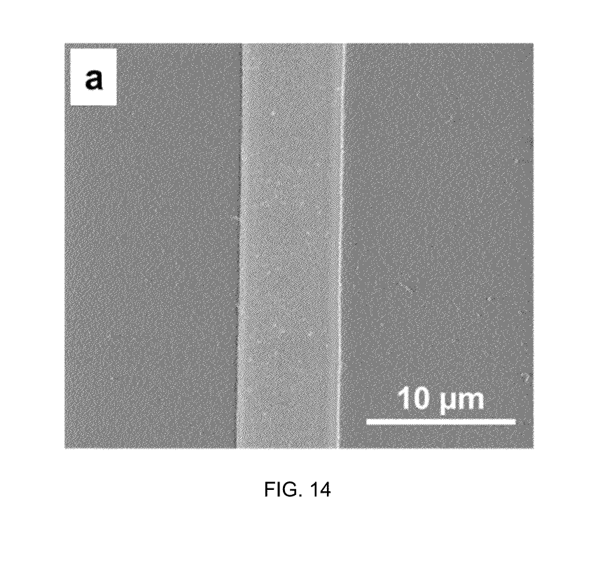

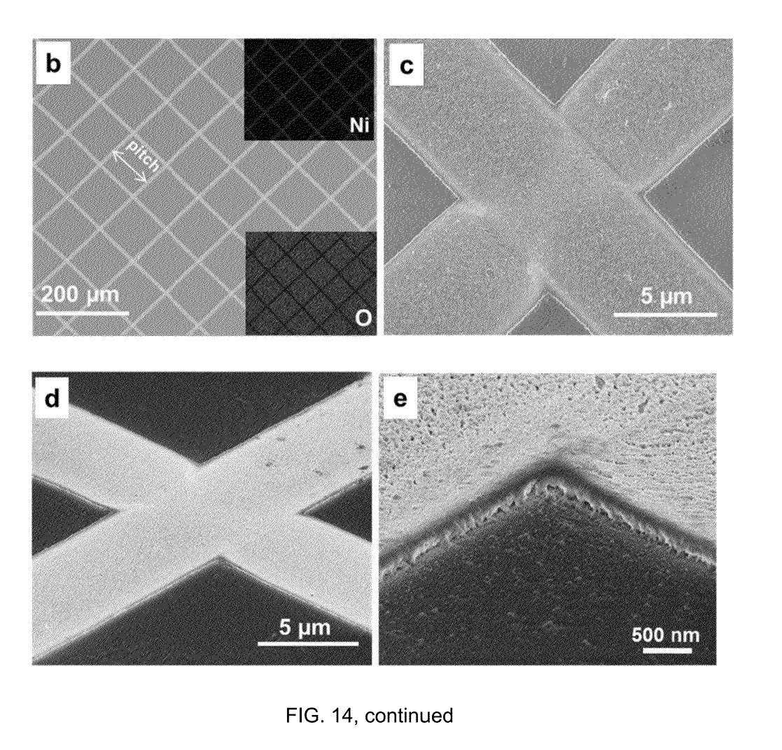

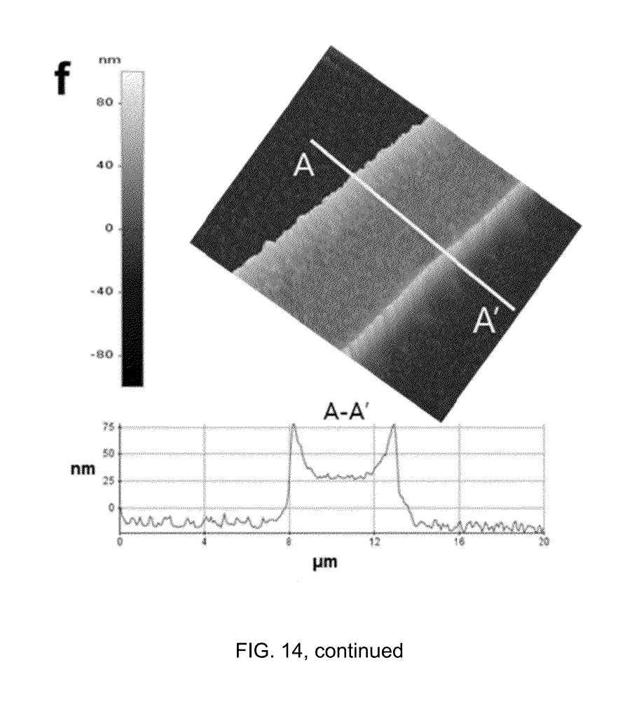

FIG. 14 (panel a) shows a scanning electron microscopy (SEM) image of an electrode line produced by a single scan of a laser beam at a power of about 26.4 mW. The line width of the electrode was measured to be approximately 6.5 μm. FIG. 14 (panel b) and FIG. 14 (panel c) show top-view SEM images of the mesh-type electrodes at different magnifications. The edges of the laser sintered electrode lines were extremely sharp, indicating that the LDW reduction sintering process can be applied to high-resolution electrode fabrication. The insets in FIG. 14 (panel b) show elemental mapping images for Ni and O acquired from energy-dispersive X-ray spectroscopy (EDX) analysis of the mesh-type electrodes on a glass substrate. EDX analysis was carried out at an accelerating voltage of 2 keV. The images showed clear contrast between Ni and O elements in the electrodes, indicating that laser irradiation removed oxygen from the NiO NP film, while the washing steps removed the unirradiated parts. FIG. 14 (panel d) and FIG. 14 (panel e) show tilted view images of the intersection area of the mesh patterns, which further confirmed the feature quality. The electrode was thicker near the edge than at the center due to thermocapillarity, and the thickness of the electrode measured by atomic force microscopy (AFM) was about 35-40 nm as shown in FIG. 14 (panel f). The root mean square (RMS) value of the surface roughness at the center area of the electrode was about 2.6 nm. In FIG. 14 (panel f), the contrast of the thickness in the cross sectional shape was distorted by the different axis scales (x-axis:μm, y-axis: nm).

Without being limited to any particular theory, the reduction mechanism of NiO thin film induced by laser irradiation may be as discussed below. The liquid in the ink was needed for the reduction of the NiO NP film. For instance, a liquid-free NiO film that was dried at ambient condition or baked dry at ˜60° C. did not induce reduction. For NiO thin films using toluene as a liquid, protons are supplied from the toluene molecules adsorbed on the surfaces of the NiO NPs and the laser irradiation initiates the reduction of NiO by the following reactions:

C₆H₅CH₃→C₆H₅CH₂⁻ (toluene anion)+H⁺ (1)

NiO+2H⁺+2e⁻→Ni+H₂O (2)

Insufficient laser power did initiate the reaction of NiO with the reducing agents in the liquid. If the laser power exceeded a threshold level, the reduced thin film underwent re-oxidation and could be damaged or destroyed in some cases. Therefore, the competing phenomena of reduction and oxidation occurred during the laser irradiation of NiO thin films deposited with NiO NP ink under the ambient conditions. The optimum laser process parameters were in a regime where reduction dominated oxidation.

Regular Ni grids made with the present method were used as a transparent conductor. FIG. 15 (panel a) shows the effect of grid pitch on substrate-based transmittance of Ni mesh electrodes on a glass substrate. A pitch of the mesh patterns was selected to obtain patterned electrodes with high transmittance, while still having low sheet resistance. The numbers on the patterns in FIG. 15 (panel b) correspond to the pitch (μm) of each 1 cm×1 cm mesh pattern. The image in FIG. 15 (panel b) was taken using printed letters as a background to illustrate the transmittance of each pattern. FIG. 15 (panel c) shows a graph of the sheet resistance and the corresponding transmittance at 550 nm wavelength as a function of grid pitch. The sheet resistance was measured by the two-terminal methods while applying conductive silver paste at two sides of each area. As the pitch increased, the sheet resistance increased almost linearly while transmittance increased rapidly until the pitch reached ˜80 μm. When the pitch was 80 μm, the mesh grids showed a transmittance of 87% while maintaining low resistance (655 Ω/sq). Although the sheet resistance was higher than the typical value of indium tin oxide (ITO), it was acceptable for low-current applications, such as touchscreen panels.

Thicker electrodes were produced by adjusting the concentration of the NiO ink and the spin speed during the thin film deposition procedures. Thus, thinner or thicker electrodes were produced for applications requiring higher transmittance and lower resistance, respectively. FIG. 15 (panel d) shows the resistivity data of the Ni electrodes as a function of laser power at a fixed 10 mm/s scan speed, which was calculated by ρ=R·A/l, where R, A and l are the resistance, the cross-section area and the length of thin single line electrodes (average thickness: 38 nm), respectively. The lowest resistivity under the optimized laser power (26-27 mW for glass substrates) was about 650 nΩ·m, which was about an order of magnitude higher than the resistivity of bulk nickel (ρ=69.3 nΩ·m at room temperature), which may be due to nanopores generated in the sintered electrode as shown in FIG. 14 (panel e), and/or due to re-oxidation or incomplete reduction. The resistivity was still low enough to be used as high resolution electrical conductors.

For an adhesion test of the Ni electrode on a glass substrate, a tape-pull test was performed several times using a conventional adhesive tape (Magic™ tape, 3M). The Ni electrode did not detach from the substrate. Similarly, after an adhesion test using a highly adhesive tape (single sided adhesive copper tape, 3M), the electrodes on the substrate were intact and only adhesive residue remained on the surface, as shown in FIG. 16 (panel a). In addition, the electrodes did not detach from the substrate after dipping in an ultrasonic bath for over 1 min.

Since the laser irradiation produced a highly localized temperature field, it was suitable for processing heat-sensitive flexible polymer substrates. FIG. 16 (panel b) shows mesh-type Ni electrodes on a polyimide substrate. The contrast of the area depended on pitch of the mesh patterns, as described above. The upper and lower insets in FIG. 16 (panel b) show bright-field microscope images of mesh patterns having 20 μm and 80 μm pitches, respectively. The laser power for reduction sintering on polyimide was about 11.5 mW with a 10 mm/s scan speed when focused through a 10× objective lens, which was lower than the power applied when using a glass substrate (26.4 mW). The lower power used on a polyimide substrate was due to the thermal property difference between glass and polyimide. Under constant heat flux loading, the induced temperature was approximately proportional to the parameter α^{0.5}k⁻¹, where a and k are the thermal diffusivity and conductivity, respectively. As shown in Table 2, the α^{0.5}k⁻¹ value of polyimide was about 3 times higher than that of the soda-lime glass.

TABLE 2
Thermal properties of soda-lime glass and polyimide substrate

| | Thermal conductivity, | Thermal diffusivity, | |
|---|---|---|---|
| | k [W/mK] | a [m²/s] | a^{0.5}/k⁻¹ |
| Soda lime | 1.4 | 9.1 × 10⁻⁷ | 6.81 × 10⁻⁴ |
| glass | | | |
| Polyimide | 0.12 | 7.75 × 10⁻⁸ | 2.32 × 10⁻³ |
| (Kapton ®) | | | |

FIG. 16 (panel c) shows a cyclic bending test result with electrodes on a polyimide substrate. A 3.8 cm×4.8 cm mesh-type electrode was fabricated on the substrate and a copper tape was attached to the opposite edges of the pad. Contact was then made to two copper blocks; one of these blocks was attached to a motorized linear stage. As the copper block moved back and forth repeatedly, the pad was subjected to cyclic bending (bending radius=0.4 cm). After over 5000 cycles, the measured resistance variation (ΔR/R₀) was less than 6%. This bendability was attributed to the strong adhesion of the Ni electrodes to the polyimide substrate and also to the resilience of the thin layer electrodes.

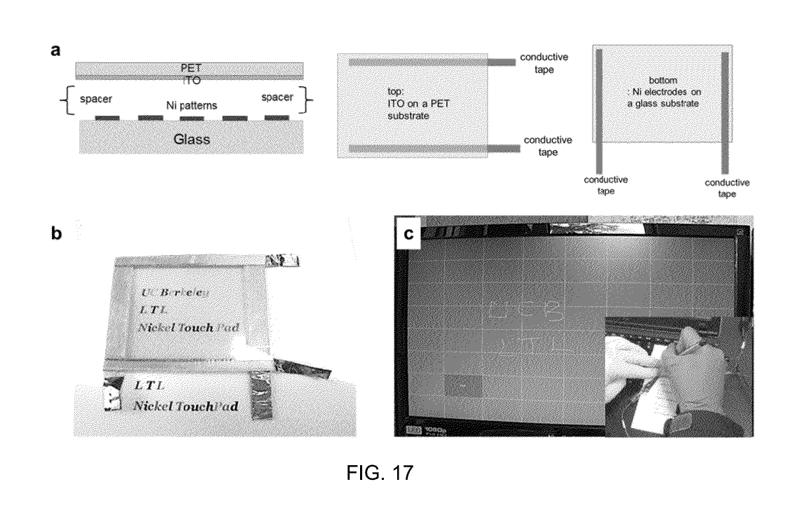

Mesh-type Ni grids on a glass substrate were used in a transparent 4-wire resistive touchscreen panel as shown in FIG. 17 (panel a) and FIG. 17 (panel b). A 3.8 cm×4.8 cm mesh grid with a 80 μm pitch was produced by the LDW process and an ITO-PET film (60 Ω/sq, transmittance: ˜79% at 550 nm, Sigma Aldrich) was used as a counter electrode. Two slips of copper tape were attached to the upper and lower sides of the ITO-PET film and another two slips of copper tape were attached to the left and right sides of the Ni grids. The active area was 3 cm×3.7 cm. A commercial USB-interface touchscreen controller was connected to the four copper electrodes with electric wires through which the voltage was applied and converted the voltage drop signals into the letters on a PC screen. No protective coating layer was required for the Ni electrodes due to strong adhesion on the substrate. The performance of the Ni touchscreen pad is shown in FIG. 17 (panel c).

### Conclusion

In summary, plastic-compatible maskless Ni electrode patterning was performed by selective laser reduction sintering of air-stable NiO NP thin films deposited by a solution-processible method. All procedures, from the materials synthesis to the laser processing, were performed under ambient conditions without using photolithographic steps. A CW laser was used to sinter and reduce the NiO NP film to a continuous Ni film in air through photothermal reaction of NiO with reducing agents in the liquid. Thin (˜40 nm) Ni electrodes with fine morphology were produced, which was facilitated by the small and uniform size of NiO NPs dispersed in the liquid without agglomeration. The resistivity of the Ni electrode was less than an order of magnitude higher compared to that of the bulk Ni. Cyclic bending, tape-pull and ultrasonic bath tests confirmed robust adhesion of the Ni electrodes on both plastic and glass substrates. Adjusting the pitch of the mesh-type thin electrode grids produced a transparent conductive panel with a transmittance higher than 87% and a sheet resistance of about 655 Ω/sq. A resistive type touch screen device using a Ni-mesh transparent conductor was produced, which showed steady performance without any protective layer over the electrodes.

Although the foregoing embodiments have been described in some detail by way of illustration and example for purposes of clarity of understanding, it is readily apparent to those of ordinary skill in the art in light of the teachings of the present disclosure that certain changes and modifications may be made thereto without departing from the spirit or scope of the appended claims. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

That which is claimed is:

1. A method for producing a nickel-containing surface coating, the method comprising:
contacting a surface of a substrate with a liquid composition comprising nickel oxide nanoparticles; and
modifying the nickel oxide nanoparticles to produce a nickel-containing surface coating on the surface of the substrate.

2. The method of claim 1, wherein the nickel-containing surface coating comprises elemental nickel.

3. The method of claim 1, wherein the modifying comprises applying a continuous wave laser to the nickel oxide nanoparticles and the applying produces a nickel surface coating.

4. The method of claim 1, wherein modifying comprises applying a pulsed laser to the nickel oxide nanoparticles and the applying produces a nickel or a nickel oxide surface coating.

5. The method of claim 1, wherein the contacting comprises spin coating the liquid composition comprising nickel oxide nanoparticles on the surface of the substrate.

6. The method of claim 1, wherein the substrate is a low glass transition temperature polymer.

7. The method of claim 1, wherein the contacting comprises printing the liquid composition comprising nickel oxide nanoparticles on the surface of the substrate.

8. The method of claim 7, wherein the contacting comprises inkjet printing, screen printing, gravure printing, flexo printing, offset printing, micro-imprinting or nano-imprinting.

9. The method of claim 7, wherein the patterned surface coating has a pitch between the nickel-containing elements ranging from 10 nm to 1000 μm.

10. The method of claim 1, wherein the nickel-containing surface coating is a patterned surface coating comprising nickel-containing elements and inter-element areas.

11. The method of claim 10, wherein the modifying comprises applying a laser in a predetermined pattern to the nickel oxide nanoparticles.

12. The method of claim 1, wherein the liquid composition comprises an organic liquid selected from toluene and alpha-terpineol and their mixtures.

13. A nickel-containing surface coating produced by the method of claim 1.

14. The nickel-containing surface coating of claim 13, wherein the nickel-containing surface coating is a nickel electrode.

15. A method for producing a liquid composition comprising nickel oxide nanoparticles, the method comprising:
treating a liquid composition comprising a nickel coordination complex under reducing conditions to produce a liquid composition comprising nickel oxide nanoparticles.

16. The method of claim 15, wherein the nickel coordination complex comprises nickel(II) acetylacetonate.

17. The method of claim 15, wherein the liquid composition comprising the nickel coordination complex further comprises a reducing agent.

18. The method of claim 17, wherein the reducing agent comprises a borane-triethylamine complex.

19. The method of claim 15, further comprising washing the nickel oxide nanoparticles.

20. The method of claim 15, further comprising dispersing the nickel oxide nanoparticles in an organic liquid selected from toluene and alpha-terpineol and their mixtures.

21. The method of claim 15, wherein the nickel oxide nanoparticles have an average diameter of 100 nm or less.

22. A liquid composition comprising nickel oxide nanoparticles produced by the method of claim 15.

23. A kit comprising:
a liquid composition comprising the nickel oxide nanoparticles of claim 15; and
an organic liquid.
